(19) United States
(12) Patent Application Publication
(10) Pub. No.: US 2015/0083755 A1
(43) Pub. Date: Mar. 26, 2015

(54) Dispensing System with Bracket

(71) Applicants: Alex Mecker, Milwaukee, WI (US); Jesse Richard, Racine, WI (US); Ronald M. Llanes, Lisle, IL (US); Kylie L. Levake, Union Grove, WI (US); Jeffrey J. Christianson, Oak Creek, WI (US); Christopher P. Wolack, Racine, WI (US)

(72) Inventors: Alex Mecker, Milwaukee, WI (US); Jesse Richard, Racine, WI (US); Ronald M. Llanes, Lisle, IL (US); Kylie L. Levake, Union Grove, WI (US); Jeffrey J. Christianson, Oak Creek, WI (US); Christopher P. Wolack, Racine, WI (US)

(21) Appl. No.: 14/038,613

(22) Filed: Sep. 26, 2013

(51) Int. Cl. B65D 83/38; F16M 13/02

(52) U.S. Cl. CPC B65D 83/38; F16M 13/02
USPC 222/183; 248/205.1

(57) ABSTRACT

A dispensing system includes a housing for receipt of a product to be dispensed and a discharge orifice for emission of the product. The housing includes at least one decorative recessed portion that does not extend completely through the housing and at least one decorative aperture that does extend completely through the housing. Further, one or more optional apertures are provided within the housing for receipt or viewing of a functional component of the system.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present disclosure relates generally to a dispensing system for a spray device, and more specifically, a dispensing system for discharging a product from an aerosol container.

2. Description of the Background of the Invention

Aerosol containers are commonly used to store and dispense a product such as air freshening agents, deodorants, insecticides, germicides, decongestants, perfumes, or any other known product suitable for dispersal in the form of particles or droplets suspended within a gas. The product is forced from the aerosol container through an aerosol valve by a hydrocarbon or non-hydrocarbon propellant, such as a compressed gas. Typical aerosol containers comprise a body with an opening at a top end thereof. The opening at the top end is in fluid communication with the aerosol valve, which is in a closed position during a resting or inoperative state and can be tilted or vertically depressed into an open position during an active or operative state for dispensing.

To facilitate their use in various circumstances, aerosol containers are often provided with a discharging apparatus, such as a dispensing system. The dispensing systems are configured to depress the valve stem of the aerosol container to release product, in some cases, to the surrounding environment. Depending upon the application, the dispensing systems can be automated, manual or both. Manual actuators include overcaps, buttons, levers, or triggers that, when depressed or otherwise activated, cause product to be dispensed from the aerosol container. For instance, an actuating cap may be attached to an aerosol container and configured to transfer a downward force to a valve stem when depressed, such that a volume of product is released through a valve assembly of the aerosol container. Alternatively, manual actuators can be provided on dispenser housings that contain the aerosol container therein. For example, the aerosol container may be partially or completely placed within the dispenser housing, which may be provided with an actuating button configured to open the aerosol valve assembly to release the product. These and various other manual-actuating mechanisms can be configured to dispense a volume of product into a room or environment containing the dispensing system.

Many conventional dispensing systems provide manual-actuating mechanisms that are only capable of being activated from one actuating position. Some dispensing systems are configured for handheld operation, for instance, by grasping a portion of the dispensing system in a user's hand and actuating with the same or different hand. Other common dispensing systems are configured for table-top operation, for instance, by resting the dispensing system on a flat surface and depressing a manual actuating button thereon. Still other common dispensing systems are configured for mounted operation, for instance, by fixing the dispensing system to another surface and dispensing product in the mounted position. In most applications, dispensing systems are capable of operating in one of the above positions, in which case the limited operating position may be a less ideal operating position and/or can quickly become tiresome or cumbersome to handle. Although dispensing systems configured for certain actuating systems may not preclude other actuating methods, for instance a table-top dispenser that can be picked up and activated in a handheld position, the user experience may be compromised. For instance, the common table-top dispensing system is not ergonomic, which leads to an uncomfortable user experience if used in the handheld position. Even further, other dispensing systems that are configured for more than one operating position typically appear utilitarian and lack aesthetics, which leads to diminished user satisfaction. In that case, the dispensing system has reduced efficacy since it may be hidden away and rarely used. Further, it is common for dispensing systems that allow for more than one operating position to not be easily interchangeable between operating positions, which may actually defeat the purpose of the multi-operable dispenser by deterring its operation.

Therefore, there is a need to provide a dispensing system that promotes user operation in a variety of settings by enabling easy usage from multiple operating positions. Further, there is a need to provide a dispensing system that allows easy maneuvering between the multiple operating positions, which may allow a user to easily grab the dispensing system for handheld operation or alternatively operate as a wall-mounted device. There is also a need to provide a dispensing system that is visually appealing to encourage placement of the system in a variety of settings, which encourages the user to leave the dispensing system in plain view for frequent use.

Therefore, there exists a need for an improved dispensing system. This invention is intended to address the above-noted needs and provide related advantages.

### SUMMARY OF THE INVENTION

In one aspect of the present disclosure, a dispensing system includes a housing for receipt of a product to be dispensed and a discharge orifice for emission of the product. The housing includes at least one decorative recessed portion that does not extend completely through the housing and at least one decorative aperture that does extend completely through the housing. Further, one or more optional apertures are provided within the housing for receipt or viewing of a functional component of the system.

According to another aspect of the present disclosure a bracket for retaining a dispenser includes a plate adapted to be secured to a wall. The plate has at least two parallel ribs extending between a lower end and an upper end thereof. A shelf extends from the lower end of the plate and at least two prongs extend from the shelf.

According to a different aspect of the present disclosure, a kit for a dispensing system includes a dispenser having a multi-directional actuation mechanism with at least two actuators for hand-held use of the dispenser to spray a product. The kit also includes a container holding the product and a bracket for operatively holding the dispenser by one of the at least two actuators.

### BRIEF DESCRIPTION OF THE DRAWINGS

FIG. 1 is an isometric view of a top, front, and right side of a dispensing system having a front cover and a rear cover;

FIG. 2 is a right side elevational view of the dispensing system of FIG. 1;

FIG. 3 is a front elevational view of the dispensing system of FIG. 1;

FIG. 4 is a rear elevational view of the dispensing system of FIG. 1;

FIG. 5 is a front elevational view of an aerosol container for use in the dispensing system of FIG. 1;

FIG. 6 is a bottom isometric view provided at an angle to illustrate an inner face of the rear cover of the dispensing system of FIG. 1;

FIG. 7 is a front elevational view of the inner face of the rear cover of FIG. 6;

FIG. 8 is a front elevational view of the dispensing system of FIG. 1 with the front cover removed;

FIG. 9 is a cross-sectional view of the dispensing system of FIG. 1 generally taken along line 9-9 thereof;

FIG. 10 is a front elevational view of an inner face of the front cover of the dispensing system of FIG. 1;

FIG. 11 is a bottom isometric view of the inner face of the front cover of FIG. 10 taken at an angle;

FIG. 12 is identical to the view shown in FIG. 11, except for the addition of a nozzle;

FIG. 13 is a right-side cross-sectional view of the dispensing system of FIG. 1 generally taken along line 13-13 thereof, with the aerosol container and the nozzle removed;

FIG. 14 depicts the dispensing system of FIG. 13 with the addition of a nozzle and aerosol container;

FIG. 15 is a top elevational view of the dispensing system of FIG. 1;

FIG. 16 is a bottom elevational view of the dispensing system of FIG. 1;

FIG. 17 is a bottom elevational view of the dispensing system of FIG. 16, with the aerosol container and the nozzle removed;

FIG. 18A is an isometric view of a top and side of the nozzle of FIG. 12;

FIG. 18B is a side elevational view of the nozzle of FIG. 18A;

FIG. 19A is an isometric view of a top, front, and right side of a shroud for holding an aerosol container;

FIG. 19B is a front elevational view of the shroud of FIG. 19A;

FIG. 19C is a side elevational view of the shroud of FIG. 19A;

FIG. 20 is a front elevational view of an alternative rear cover of the dispensing system of FIG. 1 with the shroud of FIG. 19A inserted therein;

FIG. 21 is a cross-sectional view of the alternative rear cover of FIG. 20 with the shroud of FIG. 19A, generally taken along the line 21-21 of FIG. 25;

FIG. 22 is a bottom isometric view of an inner face of the rear cover of FIG. 20 taken at an angle and without the shroud;

FIG. 23 is a front elevational view of an inner face of the rear cover of FIG. 20

FIG. 24 is a bottom isometric view of an alternative front cover of the dispensing system of FIG. 1 provided at an angle;

FIG. 25 is a right side elevational view of an alternative dispensing system having the shroud of FIG. 19A, the rear cover of FIG. 20, and the front cover of FIG. 24;

FIG. 26 is a cross-sectional view of the alternative dispensing system of FIG. 25 generally taken along line 26-26 thereof of FIG. 27;

FIG. 27 is a top elevational view of the dispensing system of FIG. 25;

FIG. 28 is a bottom elevational view of the dispensing system of FIG. 25;

FIG. 29 is a bottom elevational view of the dispensing system of FIG. 28, with the shroud removed;

FIG. 30A is an isometric view of a top, front, and right side of a mounting dock;

FIG. 30B is an isometric view of a top, front, and right side of another embodiment of the mounting dock of FIG. 30A;

FIG. 31 is an isometric view of a top, front, and right side of the mounting dock of FIG. 30A deployed on the dispensing system of FIG. 1;

FIG. 32 is a right side elevational view of the mounting dock and dispensing system of FIG. 31;

FIG. 33 is a front elevational view of the mounting dock of FIG. 30A;

FIG. 34 is a right side view of the mounting dock of FIG. 30A;

FIG. 35 is a top elevational view of the mounting dock of FIG. 30A;

FIG. 36 is a bottom elevational view of the mounting dock of FIG. 30A;

FIG. 37 is a front elevational view of the rear cover of FIG. 6 with the mounting dock of FIG. 30A deployed thereon;

FIG. 38 is a rear elevational view of the rear cover of FIG. 6 with the mounting dock of FIG. 30A deployed thereon;

FIG. 39 is a top elevational view of the dispensing system of FIG. 1 with the mounting dock of FIG. 30A deployed thereon;

FIG. 40 is a bottom elevational view of the dispensing system of FIG. 1 with the mounting dock of FIG. 30A deployed thereon;

FIG. 41 is a front elevational view of the rear cover of FIG. 20 with the mounting dock of FIG. 30B deployed thereon;

FIG. 42 is a right side elevational view of the mounting dock of FIG. 30B deployed on the dispensing system of FIG. 25;

FIG. 43 is a top elevational view of the dispensing system of FIG. 25 with the mounting dock of FIG. 30B deployed thereon;

FIG. 44 is a bottom elevational view of the dispensing system of FIG. 25 with the mounting dock of FIG. 30B deployed thereon;

FIG. 45 is a front elevational view of a pattern disposed on the front cover of the dispensing system of FIG. 1;

FIG. 46 is a rear elevational view of a pattern disposed on the rear cover of the dispensing system of FIG. 1;

FIG. 47 is a schematic diagram of a pattern on the front or rear cover of the dispensing system of FIG. 1; and

FIG. 48 is a schematic diagram of the dispensing system of FIG. 1.

### DETAILED DESCRIPTION

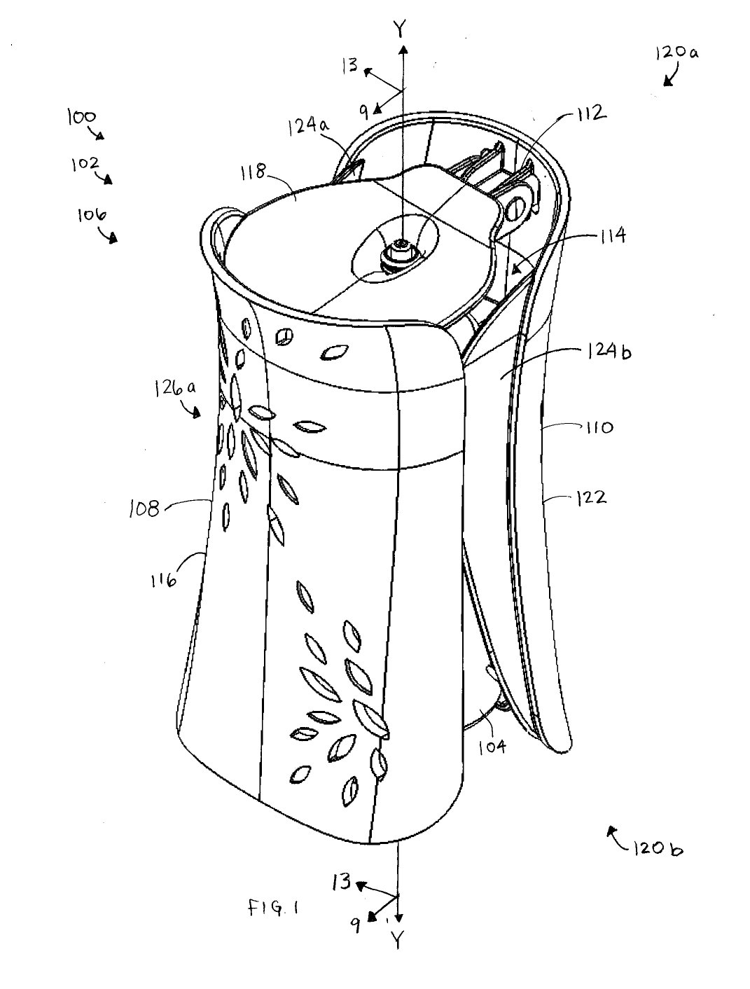

FIGS. 1-18B show a dispensing system 100 that comprises a dispenser 102 configured to receive a product container 104 therein. The dispenser 102 provides a curvilinear housing 106 that comprises a front cover 108 attached to a rear cover 110 at a pivot joint 112. The front and rear covers 108, 110 define an internal cavity 114 therebetween, where the product container 104 containing the product to be dispensed is received. In the present embodiment, the front cover 108 comprises a curved front wall 116 and a curved top cover 118 that extends transversely from the front wall 116 toward the rear cover 110 at an upper end 120a of the housing 106. The rear cover 110 comprises a curved rear wall 122 with a left wing 124a and a right wing 124b that extend toward the front cover 108. In particular, the left and right wings 124a,b span opposing sides of the housing 106 from the upper end 120a to a lower end 120b thereof and function as sidewalls to cover at least a portion of the product container 104. A front pattern 126a and a rear pattern 126b are disposed on the curved front and rear walls 116, 122, respectively, whereby each of the patterns 126a,b includes a blind hole, a through-hole, or various combinations thereof, as described below. The dispensing system 100 is activated by squeezing the front and/or rear covers 108, 110 together to release product from the product container 104 and through the top cover 118 of the front cover 108.

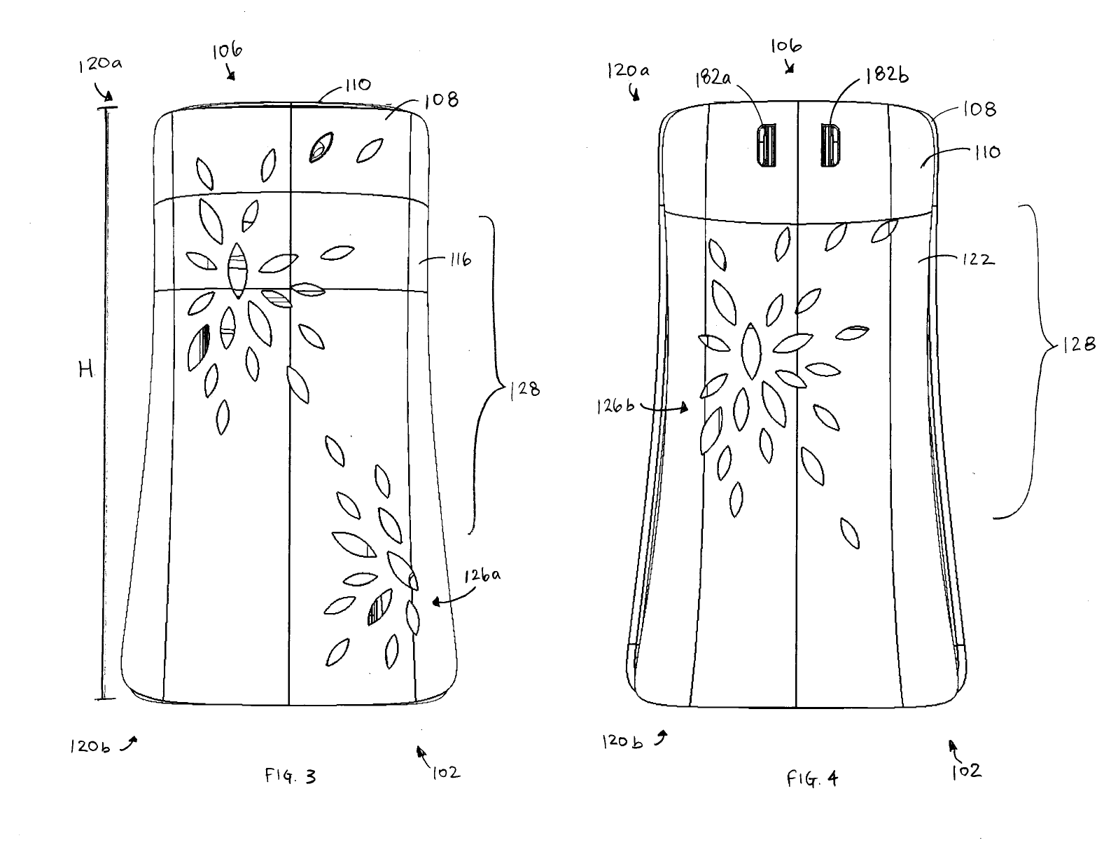

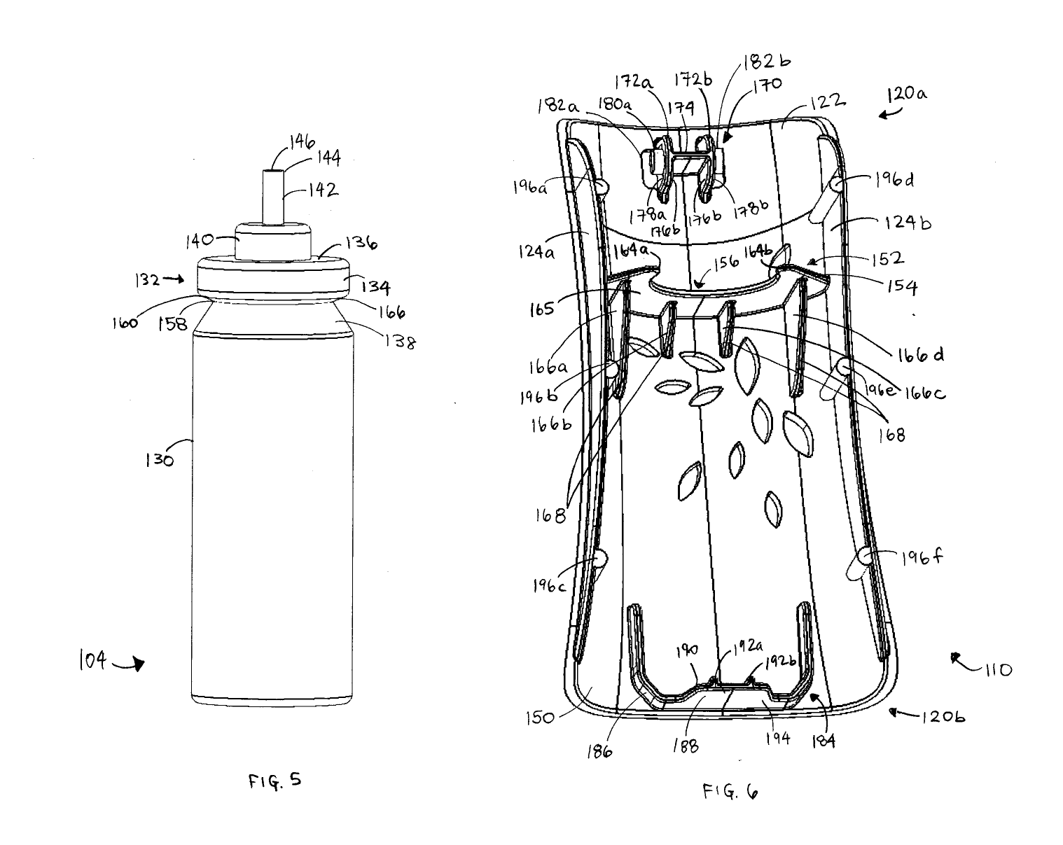

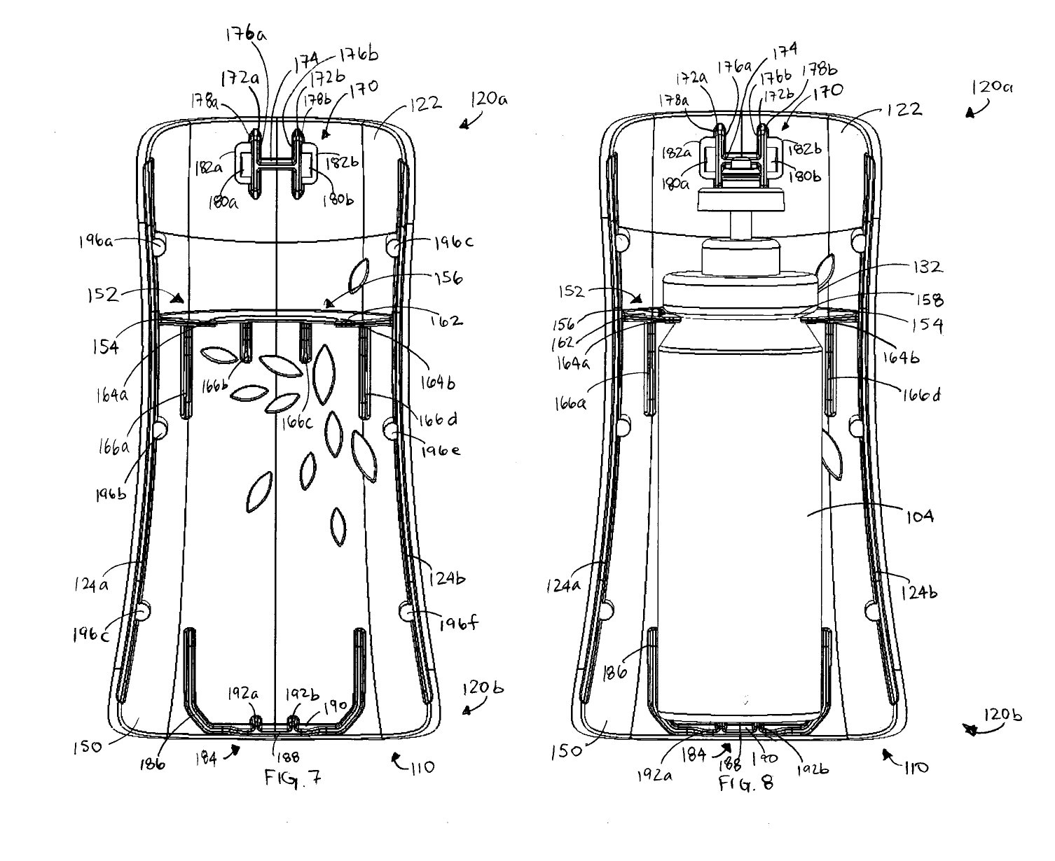

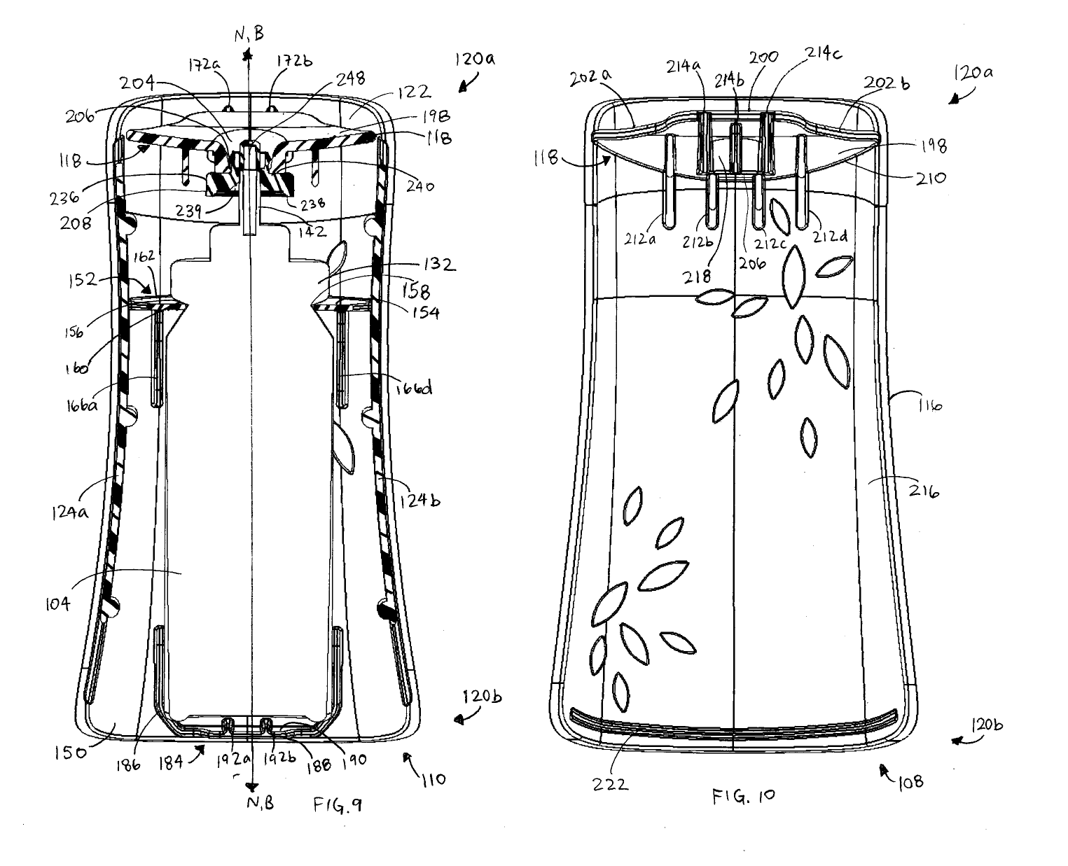

Still referring to FIGS. 1-18B, the dispensing system 100 described herein is configured to release product from a plurality of operating positions. In particular, the dispensing system 100 provides at least three modes of operation for a user to actuate the dispenser 102, including a handheld position, an upright position, and a mounted position. In the handheld position, the user can pick up the dispenser 102 and squeeze the front and/or rear covers 108, 110, i.e., first and/or second actuators, together to cause a spray of the product. It is contemplated that the curvilinear housing 106 includes ergonomic features that facilitate handheld operation, for instance, by minimizing discomfort or undue strain during use. In particular, FIGS. 3 and 4 show the front and rear walls 116, 122 flaring outwardly at the upper and lower ends 120a,b of the housing 106 with a gripping body 128 generally defined therebetween. The gripping body 128 tapers slightly inwardly into the housing 106 toward a central region thereof, which directs the user's grasp to the narrower circumferential portions of the housing 106 between the flared upper and lower ends 120a,b. It is contemplated that the gripping body 128 is optimized for user comfort during grasping and actuation of the dispenser 102 in the handheld position. The length of the gripping body 128 may comprise about 40% to about 70% of the dispenser height H. In another embodiment, the gripping body 128 is about 50% of the dispenser height H and generally centered between the flared upper and lower ends 120a,b.

Further, the dispenser 102 is configured to be actuated in an upright, standalone position. For instance, the dispenser 102 can be placed upright on a flat surface, such as an end table in a living room, with the lower end 120b of the housing 106 resting against the flat surface. In this case, the user can squeeze the front and/or rear covers 108, 110 together and cause the product 102 to be sprayed. Alternatively, the user can simply pick up the dispenser 102 from the upright position for operation in the handheld position, as described above. It is contemplated that the dispenser 102 provides a 360 degree aesthetically pleasing profile so that the dispenser is “counter-worthy” and encourages placement opportunities in plain view, such as in the middle of the table. For instance, the curved silhouette of the housing 106 and the front and rear patterns 126a,b appear pleasing and may contribute to or blend in with the overall ambience of the room containing the dispenser 102.

It is noted that in contrast to the dispenser 102 described herein, conventional dispensers are typically aesthetically designed for certain viewing angles and other angles are less preferable to be displayed by the user. For instance, conventional dispensers are utilitarian in appearance and commonly provide only one side that is decoratively appealing while other sides are flat or functional looking. Such conventional dispensers are typically placed against other objects or hidden in less exposed environments, which may decrease the frequency of its use or cause additional effort to be exerted to find the dispenser when not in the plain sight of the user. Quite differently, the dispenser 102 offers improved efficacy, since it can be placed in the open, which leads to more usage opportunities for the user.

Still with reference to FIGS. 1-18B, in a third mode of operation the dispenser 102 can be actuated from a mounted position. In particular, the dispenser 102 can be removably secured on a dock that is mounted to a wall or other vertical surface, of which at least one example will be described in further detail hereinbelow. In this case, actuation of the dispenser 102 is initiated by depressing the front cover 108 toward the mounting wall. It is contemplated that docking the dispenser 102 allows for deployment on a variety of surfaces, such as sloped or vertical surfaces and ceilings. Further, the dock provides a base for storing the dispenser 102, which minimizes the chances of the dispenser 102 being misplaced or lost by the user. Still further, the wall-mountable dispenser 102 can be easily removed from the dock for operation in other modes, such as the handheld and upright positions described above. Even further, the removable docking allows the dispenser 102 to be transported to other rooms which may need treatment by the product, such that the dispenser 102 is not constrained to just the immediate room that contains it. Yet another advantage to such a removable dispenser 102 is that it allows users to refill and clean the dispenser in a considerably easier manner than prior art devices. Further, the removability of the dispenser 102 also affords users the ability to switch the dispenser 102 for another dispenser having a different design, coloration, aesthetic look and/or functionality, which fits the same dock.

Therefore, the dispensing system 100 described herein meets a variety of user needs. The dispensing system 100 promotes user operation in a variety of settings by enabling easy usage from multiple operating positions, including handheld, upright, and mounted positions. A particular benefit of the dispensing system 100 is that it is optimized for all three operating positions, which encourages the user to select the best operational mode based on the specific treatment situation encountered by the user. The user can select the most preferable or appropriate operation without being inhibited by any structural or functional aspects of the dispensing system 100 itself. For instance, the dispensing system 100 described herein is visually appealing from all viewing angles to encourage placement of the system 100 in a variety of settings, which encourages the user to leave the dispensing system 100 in areas visible to the user. If the user desires to treat, for example, an odor in a different room, the user can easily grip the ergonomic dispensing system 100 and spray in a different room. Still further, the user may decide to have a docked dispensing system 100, whereby the dispenser 102 can be actuated with a force applied on the front cover 108 only. For instance, the user can activate the dispenser 102 by pressing their elbow against the front cover 108 if their hands are occupied. Another benefit is that the dispensing system 100 allows the user to easily interchange between the multiple operating positions. For example, the ergonomics of the dispenser 102 allow easy gripping for handheld operation or alternatively the wall-mounting dock (described below) allows for quick and easy mounting of the dispenser 102. In this manner, it is contemplated that the combination of features of the dispensing system 100 provides a versatile, three-in-one dispenser.

Turning now to FIG. 5, it is contemplated that the dispensing system 100 can hold different kinds of product containers 104 to accommodate different refill streams, including aerosols, pump-type sprayers, pressurized and non-pressurized containers, and the like. In the present embodiment, the product container 104 is an aerosolized container configured to dispense product using a propellant such as a hydrocarbon or non-hydrocarbon propellant. Non-hydrocarbon propellants may include, but are not limited to, compressed gasses, including, for example, compressed air, nitrogen, nitrous oxide, inert gases, carbon dioxide, etc., and mixtures thereof. The product container 104 may include any appropriate activation mechanism, such as valves, delivery tubes and/or nozzles, or combinations thereof. The valves may have various different configurations such as tilt valves, axial valves, and/or metered valve systems.

Still referring to FIG. 5, the product container 104 may comprise any size and volume known to those skilled in the art. In one embodiment, the product container 104 comprise a small container, such as a mini-aerosol container sold by S. C. Johnson and Son, Inc., of Racine, Wis. However, it is contemplated that the dispensing system 100 can utilize other capacities of product containers, e.g., metered dose aerosol containers with an output volume of between about 50 μL to about 300 μL. Embodiments that use smaller product containers 104 allow for a more compact implementation of the dispensing system 100. It is contemplated that a plurality of product containers 104 of the same or different sizes, aerosolized or non-aerosolized, can be provided for actuation in the dispensing system 100. Further, in another embodiment it is contemplated that the dispensing system 100 can be fashioned to only be functional with a particular size of container 104.

As shown in FIG. 5, in one embodiment the product container 104 is an aerosol container having a container body 130 for storing the product therein and a mounting cup 132 crimped to a top end thereof. The mounting cup 132 is generally cylindrical in shape with a diameter that is about the same diameter as the container body 130 or smaller. Further, the mounting cup 132 is defined by a vertically-disposed cup wall 134 that extends circumferentially therearound and a horizontally-disposed platform 136. Below the mounting cup 132, a neck 138 of the product container 104 is angled inwardly with respect to the cup 132 and the remaining portion of the container body 130. Above the mounting cup 132, a pedestal 140 extends upwardly from a central portion of the horizontally-disposed platform 136 to support a valve stem 142 that protrudes centrally therefrom. A distal end 144 of the valve stem 142 includes a valve orifice 146, while a proximal end of the valve stem 142 extends through the pedestal 140 to a valve assembly (not shown) that is disposed internally within the product container 104. When the distal end 144 of the valve stem 142 is depressed, the valve assembly is in an open or operative state and a volume of the product stored in the product container 104 is discharged through the valve orifice 146. The contents of the product container 104 may be discharged in a continuous or metered dose. Further, the discharging of the contents of the product container 104 can be effected in any number of ways, e.g., single or multiple continuous or metered discharges, through a partial opening of the valve assembly or valve stem 142, through a lock and key structure, through a metering or sub-metering chamber, and the like. When the depressive force on the distal end 144 of the valve stem 142 is removed, the valve assembly returns to the closed or non-operative state whereby no discharge of product occurs.

Still referring to FIG. 5, the product container 104 may include a fragrance, air freshener, or odor eliminator, or any other product disposed within a carrier liquid, a deodorizing liquid, or the like. For example, the fluid may comprise OUST, an air and carpet sanitizer for household, commercial, and institutional use, or GLADE, a household deodorant, both sold by S. C. Johnson and Son, Inc., of Racine, Wis. The fluid may also comprise other actives, such as sanitizers, air and/or fabric fresheners, cleaners, odor eliminators, mold or mildew inhibitors, pest control actives such as insecticides or insect repellents, and the like, or that have aromatherapeutic properties. The fluid alternatively comprises any fluid known to those skilled in the art that can be dispensed from a container, such as those suitable for dispersal in the form of particles or droplets suspended within a gas. In other embodiments, the product container 104 may contain a solid product for dispersal in the form of a powder, pellets, particulates, etc. The dispensing system 100 is therefore adapted to dispense any number of different fluid or product formulations.

In certain embodiments, the product is an insecticide, an insect repellant, or an insect attractant. Alternatively, the product may be a disinfectant, sanitizer, air purifier, aromatherapy scent, antiseptic, air-freshener, and/or deodorizer containing certain terpenes. Other examples of products include fragrances (e.g., natural and synthetic oils), odor eliminators, such as triethyleneglycol and/or propylene glycol, antimicrobials, anti-bacterials, corrosion inhibitors, pH adjustors, preservatives, organic acids, various natural and artificial perfumes and the like, or any other active ingredient(s) that are usefully dispersed into the air. Non-limiting examples of these perfumes include animal-based and plant-based natural perfumes, and artificial perfumes such as alcohols, phenols, aldehydes, ketones, terpenes, and esters.

The fragrance according to this disclosure may comprise one or more fragrant materials or materials that provide chemically active vapors. In one embodiment, the fragrance can comprise and/or include volatile, fragrant compounds including, but not limited to natural botanic extracts, essences, fragrance oils, and so forth. As is known in the art, many essential oils and other natural plant derivatives contain large percentages of highly volatile scents. In this regard, numerous essential oils, essences, and scented concentrates are commonly available from companies in the fragrance and food businesses. Non-limiting examples of oils and extracts include those derived from the following plants: almond, amyris, anise, armoise, bergamot, cabreuva, calendula, canaga, cedar, chamomile, coconut, eucalyptus, fennel, jasmine, juniper, lavender, lemon, lemongrass, orange, palm, peppermint, quassia, rosemary, thyme, and so forth.

Further, a wide variety of volatile fragrances may be used that may optionally also have insect control attributes. In one embodiment, the product contains an active ingredient that is an insecticide and/or insect repellent, an organic phosphorous insecticide, a lipidamide insecticide, a natural repellent such as citronella oil, a natural pyrethrin, a pyrethrum extract, or a synthetic pyrethroids. Suitable synthetic pyrethroids are acrinathrin, allethrin as D-allethrin, Pynamin®, benfluthrin, bifenthrin, bioallethrin as Pynamin Forte®, S-bioallethrin, esbiothrin, esbiol, bisoresmethrin, cycloprothrin, cyfluthrin, beta-cyfluthrin, cyhalothrin, lambda-cyhalothrin, cypermethrin, alpha-cypermethrin, beta-cypermethrin, cyphenothrin, deltamethrin, empenthrin, esfenvalerate, fenpropathrin, fenvalerate, flucythrinate, taufluvalinate, kadethrin, permethrin, phenothrin, prallethrin as Etoc®, resmethrin, tefluthrin, tetramethrin, tralomethrin, metofluthrin, transfluthrin, and/or combinations thereof. In alternative versions, the volatile insecticide is selected from the group consisting of transfluthrin, metofluthrin, vapothrin, permethrin, prallethrin, tefluthrin, and esbiothrin.

Turning now to FIGS. 6-9, the rear cover 110 is shown to include the curved rear wall 122 with left and right wings 124a,b extending from left and right sides thereof, respectively. An inner face 150 of the curved rear wall 122 includes a collar 152 to assist in retaining the product container 104, as shown in FIGS. 8 and 9. With reference again to FIGS. 6-9, the collar 152 comprises a collar platform 154 that extends from the inner face 150. A semi-circular cutout 156 is provided within the platform 154 to engage and support the product container 104 at a neck thereof, and more preferably, at a narrow portion 158 below the mounting cup 132. The product container 104 rests on the collar 152 such that a lower surface 160 of the mounting cup 132 abuts an upper side 162 of the collar platform 154. In other embodiments the mounting cup 132 of the product container 104 is adjacent to the collar platform, but need not touch or abut same. In the present embodiment, the collar 152 secures the product container 104 by a snap-fit connection, whereby a pair of collar tips 164a,b extending from each endpoint of the collar platform 154 defining the semi-circular cutout 156 provide a distance therebetween that is slightly less than the diameter of the neck 138 and/or narrow portion 158 of the container 104. In this embodiment, the collar tips 164a,b and/or additional portions of the collar 152 and/or rear wall 122 temporarily resiliently deform during the insertion or removal of the product container 104.

As further shown in FIG. 6, an underside 165 of the collar 152 is provided with a set of collar support ribs 166a-d that permanently join the collar 152 to the inner face 150. It is contemplated that the collar 152 is also permanently joined to the inner face 150 and the collar support ribs 166a-d provide additional structural integrity, particularly over frequent insertions and removals of the product container 104 therefrom, over continuous actuation of the container 104 during dispensing, and/or for holding the weight of the product container 104. In the present embodiment, four longitudinally-disposed collar support ribs 166a-d are evenly spaced about the underside 165 of the collar 152, with the two outermost ribs 166a,d slightly larger in size than the two innermost ribs 166b,c. It is noted that any number, size, shape, or configuration of collar support ribs 166a-d can be provided. In this particular embodiment, each collar support rib 166a-d defines a sloped edge 168 that slopes from the collar 152 downwardly and inwardly toward the inner face 150. The sloped edge 168 may be in conformity with the geometry of the product container 104 and minimize material required for construction. It is contemplated that the collar 152, collar support ribs 166a-d, and curved rear wall 122 are integrally formed, such as by injection molding, or may be made from separate components that are fitted or attached to one another in a permanent or removable manner.

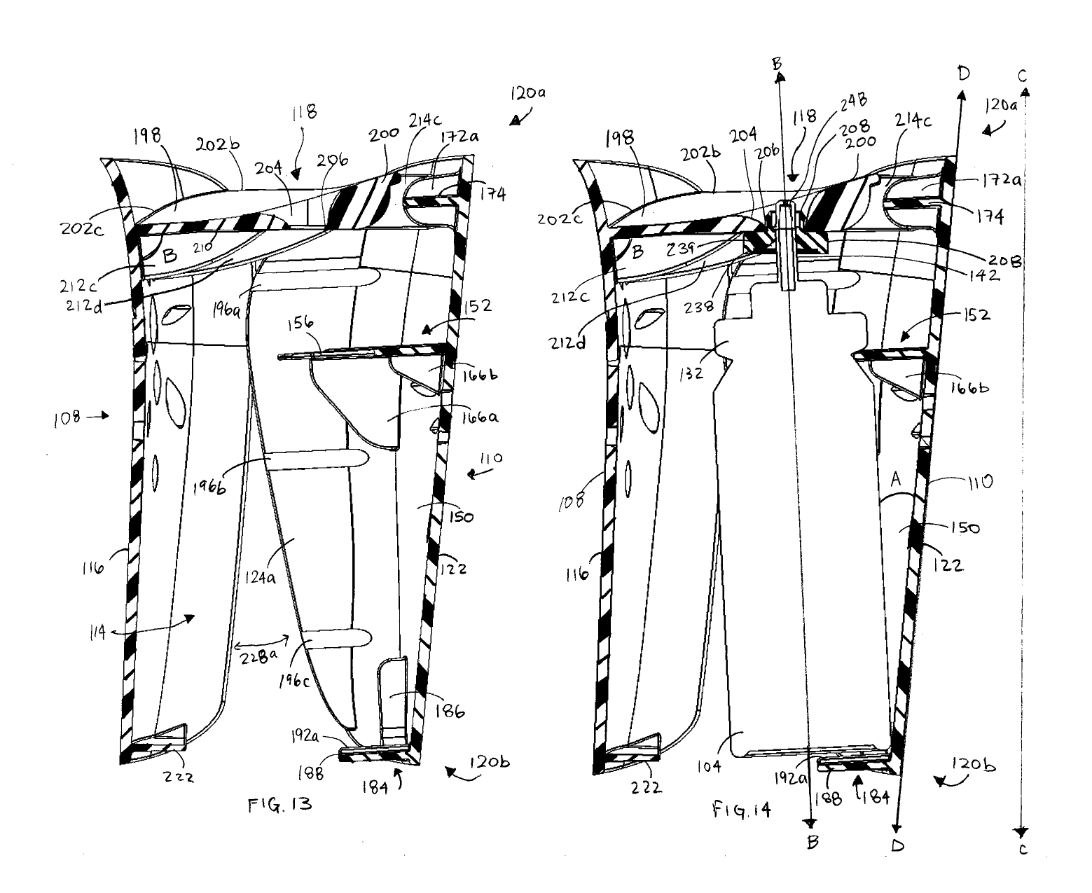

Referring now to FIGS. 8 and 9, the collar 152 is disposed generally within an upper half of the curved rear wall 122 such that the product container 104 is held entirely within the bounds of the curved rear wall 122 without any portions protruding beyond the upper or lower ends 120a,b. Turning to FIG. 14, it may be seen that the collar 152 is adapted to position the product container 104 at an angle A away from the curved rear wall 122 so that the valve orifice 146 points away from the rear wall 122 as well. More specifically, structure internal to the dispenser 102, including the collar 152 and/or other portions of the housing 106, e.g. portions defining the lower end 102b, cause a longitudinal axis of the container or valve (see axis B) to be angled or not parallel to an axis defined by a flat support surface such as a wall (see axis C) or an axis (see axis D) defined by a section of a surface of the housing 106 adjacent the support surface. In one particular embodiment, the axis C and D are parallel with one another. In another aspect, the product container may be generally referred to as being angled away from a support surface, which indicates that the product ejected from the valve orifice is initially directed away from the support surface. It is contemplated that the angle A is between about 4 degrees to about 10 degrees. In some embodiments, the angle A is between about 5.5 degrees to about 8.5 degrees. In one particular embodiment, the angle A is about 6 degrees to about 8 degrees. With reference again to FIG. 14, it may be seen that the collar 152 is angled downwardly from the curved rear wall 122 toward the lower end 120b. The collar support ribs 166a-d are also angled downwardly to tilt the product container 104 forward.

Referring back to FIGS. 6-8, a hinge 170 is provided at the upper end 120a of the curved rear wall 122 to form a portion of the pivot joint 112. The hinge 170 comprises a pair of fins 172a,b that are U-shaped and horizontally spaced apart by a fin support 174 disposed therebetween. The fin support 174 is a horizontal surface that is permanently affixed to adjacent faces 176a,b of the fins 172a, b, respectively, and to the inner face 150 of the curved rear wall 122 to provide structural integrity. Outer faces 178a,b of the fins 172a, b are provided with posts 180a,b, respectively, that are generally cylindrical structures adapted to be received in corresponding structures of the front cover 108 to form the pivot joint 112. Cutouts 182a,b are provided on the curved rear wall 122 behind the posts 180a,b to facilitate operation of the pivot joint 112. In particular instances, the rotational movement of the front cover 108 at various angles may cause portions of the front cover 108 to project through the cutouts 182a,b.

Referring to FIGS. 6-9, a tongue 184 is disposed at the lower end 120b of the curved rear wall 122 and is adapted to extend beneath the product container 104. The tongue 184 comprises a generally U-shaped rib 186 with a tab 188 extending centrally therefrom. The tab 188 is a rectangular protrusion having a top side 190 provided with a pair of ridges 192a, b and a bottom side 194 that is generally flat (see FIG. 6). It is contemplated that the tab 188 protects at least a portion of the bottom of the product container 104, prevents accidental slippage of the container 104 from the dispensing system 100, and/or guides the insertion of the container 104. The tongue 184 also facilitates certain operational modes of the dispensing system 100, such as the mounted position, as described further hereinbelow. Further, the tongue 184 may be angled downwardly from the curved rear wall 122 in a similar manner as the collar 152 described above.

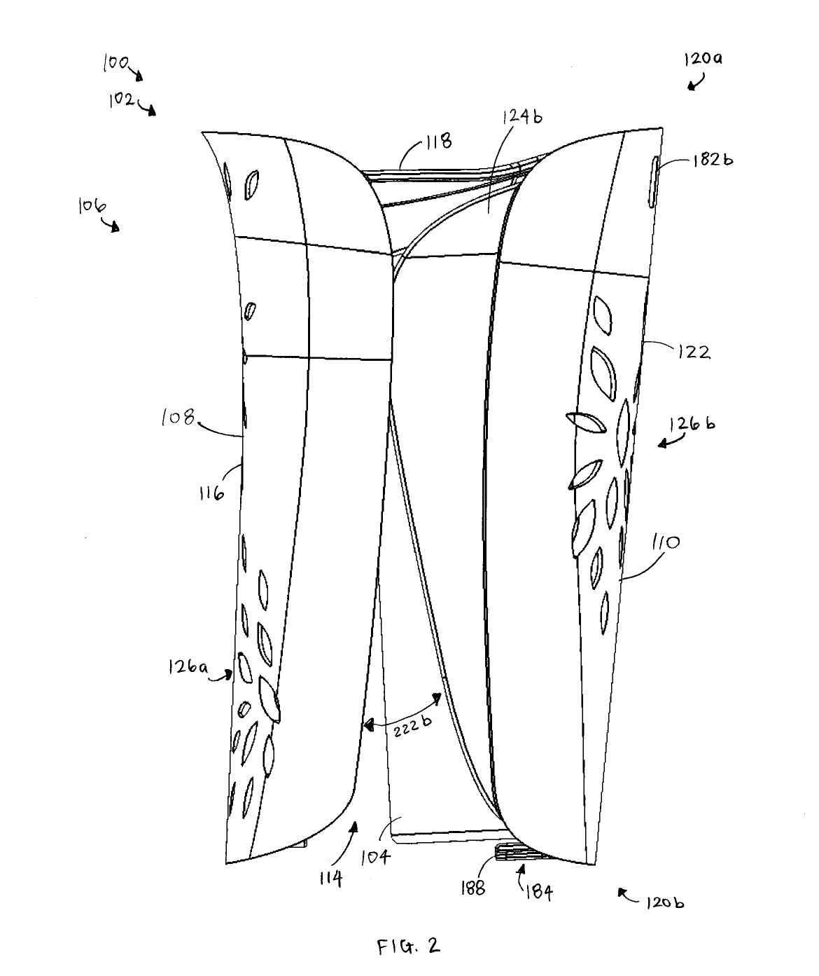

Turning now to FIGS. 1, 2, 6 and 13, the rear curved wall 122 is attached to the left and right wings 124a,b that extend forwardly toward the front cover 108. The wings 124a,b may be partially covered by edges of the front cover 108 as shown in FIG. 2. The wings 124a,b are shaped to taper downwardly from the upper end 120a of the dispenser 102 to the lower end 120b thereof. It is contemplated that the wings 124a,b conceal at least a portion of the product container 104 and the internal contents of the dispenser 102 that appear functional, such as the general area of the mounting cup 132, the valve stem 142, and the collar 152. Lower portions of the product container 104 are partly revealed by the tapered form of the left and right wings 124a,b to provide visual indication to the user that the product container 104 is inserted within the dispenser 102 and/or to permit the user to identify the type of container 104 being dispensed. In the present embodiment, the left and right wings 124a,b are slightly offset from the left and right edges of the curved rear wall 122 so that they appear recessed behind the front cover 108 and the rear cover 110, as shown in FIGS. 1 and 2. Turning to FIGS. 6 and 13, a plurality of pillars 196a-f are integrally formed with the left and right wings 124a,b and the inner face 150 of the curved rear wall 122. The pillars 196a-f are spaced apart on the left and right wings 124a,b to provide further structural integrity thereto and may be different lengths to correspond to the tapering of the wings 124a,b. For instance, pillars 196a,d are disposed at the widest portion of the left and right wings 124a,b, respectively, and have the longest lengths; pillars 196c,f disposed at the narrowest portion of the wings 124a,b, respectively, have the shortest lengths; and pillars 196b,e disposed at middle portions of the wings 142a,b have intermediate lengths.

Referring to FIGS. 3 and 13, the front cover 108 comprises the curved front wall 116 and the top cover 118 that extends generally transversely from the upper end 120a of the wall 116 toward the curved rear wall 122. It is contemplated that the curved front wall 116 and the top cover 118 are permanently affixed together or integrally formed from a single injection mold, such that an angle B between the front wall 116 and the top cover 118 is fixed and approximately 90 degrees, as shown in FIG. 13. Further, as shown in FIG. 3, the curved front wall 108 is generally greater in width than the curved rear wall 122, so that the rear wall 122 is not visible from the front view of the dispenser 102. In this case, the greater width of the curved front wall 108 allows the left and right wings 124a, b to extend behind the edges of the wall 108.

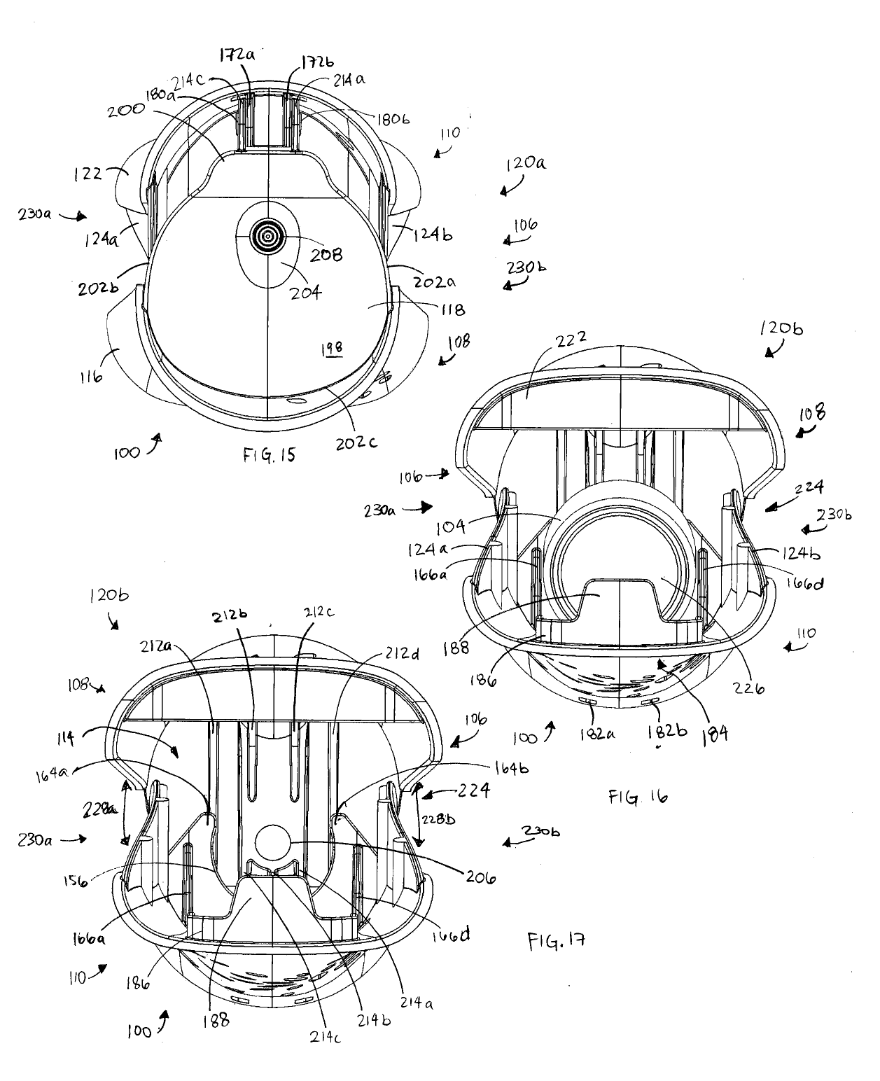

Referring to FIGS. 9, 10, 13 and 15, the top cover 118 comprises a concave surface 198 that slopes upwardly from the curved front wall 108 to the curved rear wall 110, whereby the top 118 integrally extends to a flat, inclined edge 200 that protrudes toward the pivot joint 112. As shown in FIG. 15, it may be generally stated that the concave surface 198 defines a curved surface that curves inwardly from its left and right rounded edges 202a,b and a front rounded edge 202c that is joined to the curved front wall 108. With reference again to FIG. 13, the top cover 118 is recessed within the dispenser 102, such that the curved front and rear walls 108, 110 continue to extend above the inclined edge 200 and the rounded edges 202a,b,c. A discharge sink 204 surrounding a discharge orifice 206 is provided on the top cover 118 for releasing the product therethrough. In particular, the discharge sink 204 is defined by a downwardly sloped, circular, oval or oblong-shaped well on the top cover 118 that terminates with the discharge orifice 206. It is contemplated that the discharge sink 204 facilitates in concealing certain functional aspects of the dispenser 102, such as a nozzle 208 (see FIGS. 14 and 15) that is received therethrough. In the present embodiment, the discharge sink 204 and discharge orifice 206 are provided off-centered on the top cover 118, and more particularly off-centered on the concave surface 198 toward the inclined edge 200. In other embodiments, the discharge sink 204 and the discharge orifice 206 may be centered or otherwise positioned elsewhere.

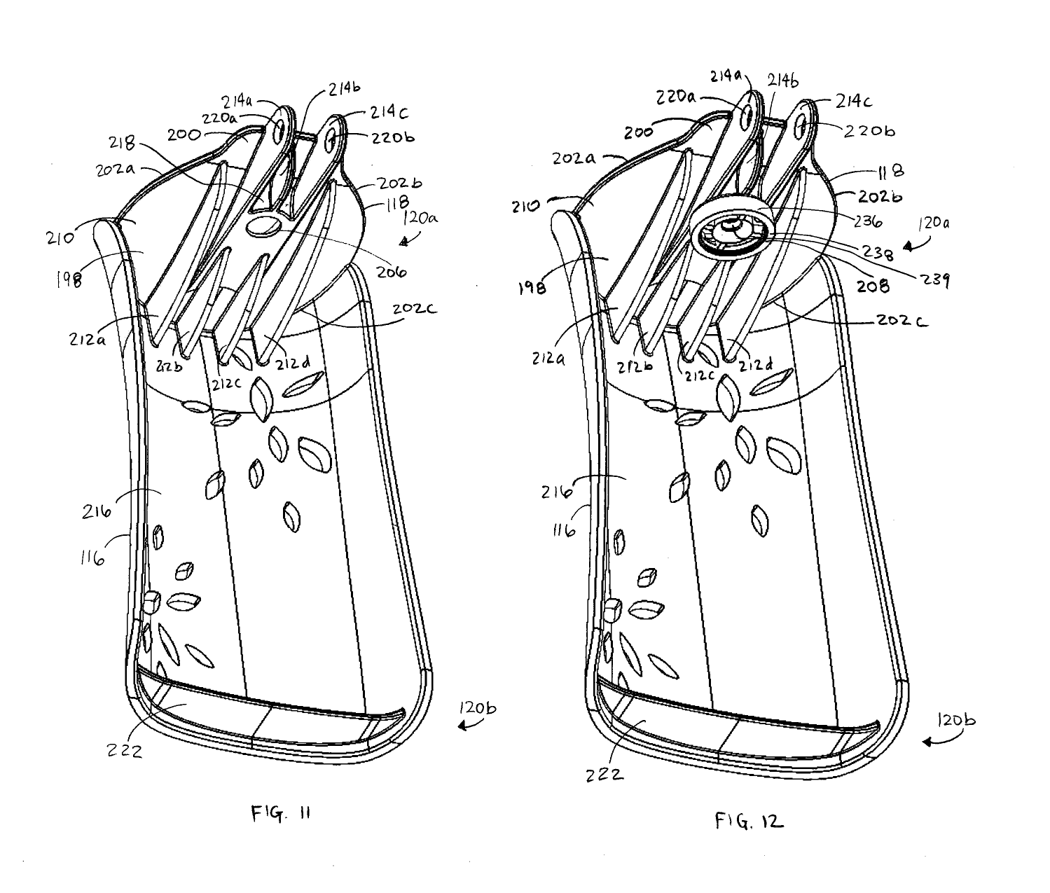

Referring to FIGS. 11 and 12, an inner surface 210 of the top cover 118 is shown that includes a plurality of structural ribs 212a-d and a plurality of hinging ribs 214a-c. The structural ribs 212a-d extend from the front rounded edge 202c of the top cover 118 toward the opposing end thereof, i.e., toward the inclined edge 200 or curved rear wall 122, and are integrally formed with an inner face 216 of the curved front wall 108. The structural ribs 212a-d may vary in number, shape and/or size and provide additional structural integrity to the permanent connection between the top cover 118 and the curved front wall 108. In the present embodiment, the inner-disposed structural ribs 212b,c are shorter in length than the outer-disposed structural ribs 212a,d so as not to occlude the discharge orifice 206. For instance, the inner-disposed structural ribs 212b,c terminate prior to reaching the discharge orifice 206, while the outer-disposed structural ribs 212a,d continue beyond the orifice 206 contained therebetween and terminate near the inclined edge 200. The structural ribs 212a-d may be similar in shape as the collar support ribs 166a-d and may also have rounded or sloped edges 168 as previously described.

Still referring to FIGS. 11 and 12, the plurality of hinging ribs 214a-c are located between the outer-disposed structural ribs 212a,d on the inner surface 210. In particular, outer-disposed hinging ribs 214a,c are spaced apart to encompass a portion of the inner-disposed structural ribs 212b,c, the discharge orifice 206, and an intermediate hinging rib 214b provided therebetween. The intermediate hinging rib 214b is shorter in length than the outer-disposed hinging ribs 214a,c and generally spans from a discharge sink underside 218 toward the inclined edge 200. Therefore, the intermediate hinging rib 214b is not visible from a top view of the top cover 118. In contrast, the outer-disposed hinging ribs 214a,c extend beyond the inclined edge 200 and are thus visible from the top view. In particular, each of the outer-disposed hinging ribs 214a,c includes a post orifice 220a,b, respectively, configured to receive the posts 180a,b provided on the curved rear wall 110. It is contemplated that the front cover 108 can be snapped onto the rear cover 110 by snappingly-engaging the post orifices 220a,b with the posts 180a,b to form the pivot joint 112 that permits the front cover 108 to rotate about the rear cover 110. Therefore, the outer-disposed hinging ribs 214a,c are adapted to temporarily resiliently deform during the snapping-on or snapping-off of the front cover 108. It is also contemplated that this resilient deformation of the hinging ribs 214a,c may be in combination with, or in lieu of, any resilient deformation of the hinge 170 and components thereof on the rear cover 110. It is further contemplated that the curved front wall 116, the top cover 118, the structural ribs 214a-d and the hinging ribs 214a-c are preferably integrally formed with one another. However, in a different embodiment the aforementioned structure is affixed to one another in a preferably permanent or otherwise secure manner.

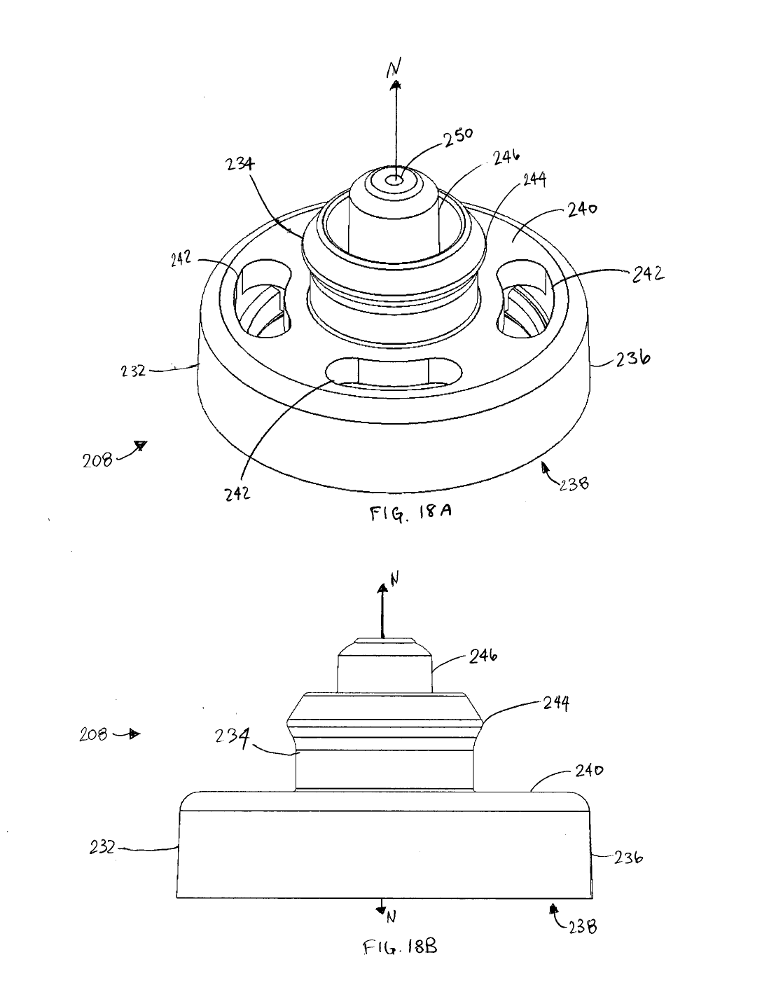

Referring yet again to FIGS. 11 and 12, a ledge 222 is provided that spans across portions of the inner face 216 of the curved front wall 108 at the lower end 120b thereof. It is contemplated that the ledge 222 provides additional structural integrity to the curved front wall 108 over frequent dispensing operations that require the front wall 108 to be depressed against the curved rear wall 122. It is noted that the shape and structural integrity of the components of the front cover 108 are configured to translate an actuation force onto the valve stem 142 of the product container 104 to result in a discharge of the product. Further, it is noted that the nozzle 208 is optionally provided and may be snap-fit into the discharge orifice 206, integrated with the discharge orifice 206, or provided in combination with the product container 104. As shown in the bottom views of FIGS. 16 and 17, the dispensing system 100 provides a hole or open base 224 at the lower end 120b to allow viewing of functional components therein and to allow visibility of the product container 104. In one embodiment, the product container 104 includes a date code (not shown) printed on the bottom surface 226 of the container 104 and/or other information pertaining to the container 104, which may be useful for the user to know in order to properly operate the dispensing system 100. Further, the open base 224 of the dispensing system 100 allows the user to see if there is a product container 104 secured therein, including the type of product or container 104, the number of containers 104, the size of the container 104, and/or a level of product within the container 104. In the present embodiment, the open base 224 is a hole that is defined between the front cover 108 and the rear cover 110 at the lower end 120b of the housing 106. In some embodiments, the open base 224 is defined between the ledge 222 of the front cover 108 and the tongue 184 at the lower end of 120b of the housing 106. Further, it is contemplated that the open base 224 is defined by a wall with an aperture or opening provided therein, so that the opening permits the user to view various internally-disposed functional components of the dispensing system 100, such as portions of the product container 104.

Referring to FIGS. 13 and 17, it is similarly contemplated that a pair of left and right side gaps 228a,b, respectively, allow viewing of functional components of the dispensing system 100. The left and right side gaps 228a,b are holes disposed on left and right sides 230a,b, respectively, of the dispensing system 100. In the present embodiment, the left and right side gaps 228a,b are defined between the left and right wings 124a,b and the left and right portions of the front cover 108. As described previously, the tapered form of the left and right wings 124a,b exposes the internal cavity 114 of the housing 106, which allows the user to check if the product container 104 is inserted, if it is inserted properly, to identify the type of container 104 and product being dispensed, and/or other internally-disposed components of the dispensing system 100. Therefore, in the present embodiment, the left and right sides 230a,b minimize the visibility of certain functional components by way of the left and right wings 124a, b, which conceal some functional aspects including the mounting cup 132, and also permit visibility of other functional components such as the product container 104. It is contemplated that other configurations can be provided about the left and right sides 230a,b of the housing 106, including a plurality of holes of various shapes and sizes on the left and right sides that allow the user to view functional components therein. Further, it is contemplated that the various holes can be connected. For instance, the left and right side gaps 228a, b can be connected to the open base 224 and altogether considered as a single hole, as shown in FIG. 17.

Turning now to FIG. 9, the nozzle 208 is adapted to connect the valve stem 142 of the product container 104 to the discharge orifice 206. In particular, as shown in FIGS. 18A and B, the nozzle 208 comprises a first receptacle 232 and a second receptacle 234 disposed thereabove, whereby the receptacles 232, 234 are integrally formed and stacked along a longitudinal axis N. The first receptacle 232 comprises a first cylindrical wall 236 that extends upwardly from a bottom end 238 to an abutment surface 240. The bottom end 238 faces the product container 104 and includes an aperture 239 for receipt of the valve stem 142 therein (see FIGS. 9, 12, and 14). The abutment surface 240 opposite the bottom end 238 is a horizontally-disposed platform that engages various portions of the housing 106, such as a portion of the housing 106 that surrounds the discharge orifice 206. In one embodiment, the abutment surface 240 is in flush contact with the top cover 118. In another embodiment, the abutment surface 240 engages one or more of the structural ribs 212a-d and/or hinging ribs 214a-c, such as the outer-disposed hinging ribs 214a,c as shown in FIG. 12. It is contemplated that the abutment surface 240 transfers an actuating force onto the valve stem 142 when such force is applied on the front cover 108 and/or rear cover 110. In the present embodiment, the abutment surface 240 is further provided with a plurality of cavities 242 (see FIG. 18A), which may reduce the weight and material comprising the nozzle 208.

The second receptacle 234 comprises a second cylindrical wall 244 that is circumferentially spaced about a discharge tube 246 to protect the narrow, thin tube 246 from being disturbed. The discharge tube 246 provides an internal conduit 248 (see FIGS. 9 and 14) and an outlet 250 that are aligned with the longitudinal axis N and provide a path for a flow of the product stream. It may be seen in the embodiment depicted in FIG. 9 that the longitudinal axis N is coincident with the longitudinal axis B of the product container 104. When the front cover 108 and/or the rear cover 110 are depressed inwardly and downwardly toward the product container 104, i.e., rotated about the hinge 170, the top cover 118 moves the nozzle 208 toward the product container 104 by contact with the abutment surface 240. Subsequently, internal surfaces defining the aperture 285 that the valve stem 142 is seated within contact same to open and release the product contained within the container 104. It is contemplated that the nozzle 208 can be used in conjunction with a variety of different product containers 104. Further, the first and/or second receptacles 232, 234, and the aperture 239 may have a conical, frusto-conical, cylindrical, or annular shape that is configured to receive various valve orifices 146 of a variety of valve stems 142. Still other nozzles known in the art can be used and may have a variety of nebulizing and/or misting effects to distribute the product from the housing 106. It is further noted that the nozzle 208 may be integrally molded with the housing 106, such as the top cover 118 of the housing, or the nozzle 208 may be snap-fitted into portions defining the discharge orifice 206 of the top cover 118. As such, it is envisioned that the dispenser 102 can be used with multiple types of product containers 104 and/or nozzles 208, each of which may have a variety of different geometries.

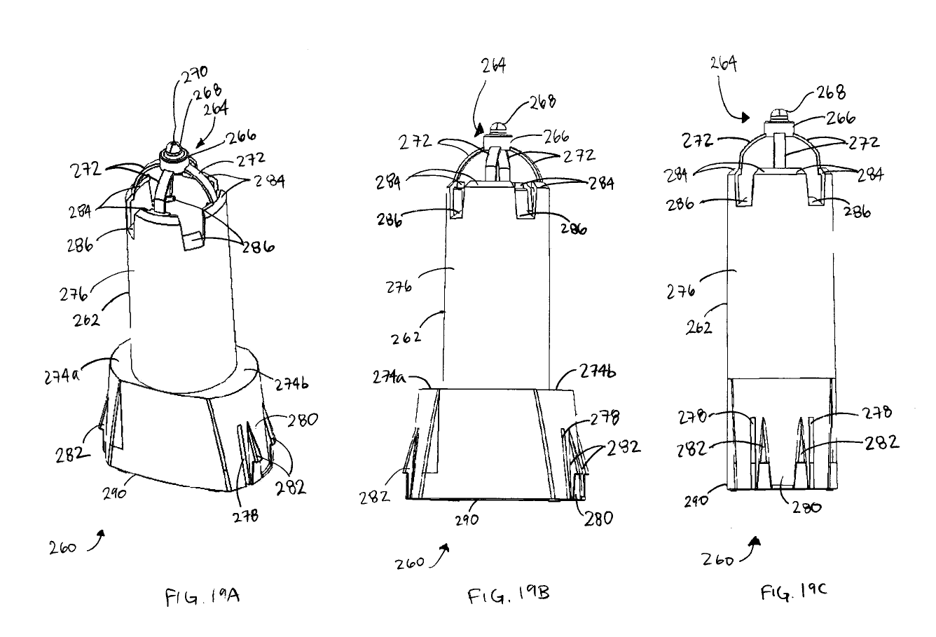

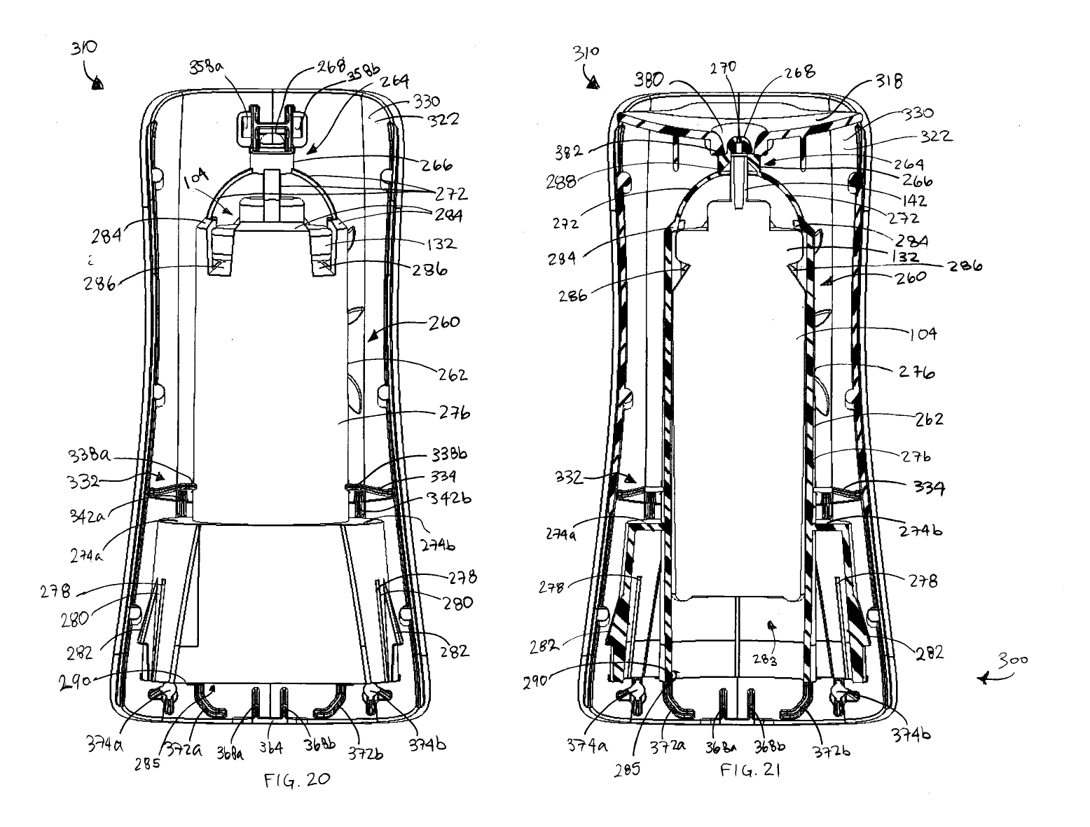

Turning now to FIGS. 19A-C, an alternative nozzle-type structure comprises a shroud 260 that can accommodate product containers 104 having a multiplicity of widths and lengths. The shroud 260 includes a body portion 262 attached to an actuator socket 264. The actuator socket 264 includes a cylindrical receptacle 266 and a bulbous end 268 with a flow passage 270 extending therethrough (see FIGS. 19A and 21). The actuator socket 264 is attached to the body portion 262 by a plurality of flexible members 272 that allow one or both of the actuator socket 264 and the body portion 262 to be displaced toward one another. A lower end of the body portion 262 includes a left shoulder 274a and a right shoulder 274b extending from an exterior surface 276 thereof. Each shoulder 270a,b includes a pair of slits 278 that define a flexible arm 280 therebetween. Each flexible arm 280 has a pair of tapered protrusions 282 extending outwardly therefrom. It is contemplated that the tapered protrusions 280 are adapted to allow the shroud 260 to be interchangeably used in other dispensing systems, such as the dispensing system of U.S. patent application Ser. No. 13/138,768.

Referring now to FIGS. 20 and 21, the shroud 260 is adapted to receive the product container 104 into an internal cavity 283 of the body portion 262 through an aperture 285 in a bottom end 290 thereof. Upon insertion of the container 104, the valve stem 142 is disposed within the actuator socket 264 (see FIG. 21). In the present embodiment, the shroud 260 includes a plurality of flexible upper internal shoulders 284 that snap over the mounting cup 132 of the product container 104 and a plurality of flexible lower internal shoulders 286 that snap underneath the mounting cup 132. In use, the upper and lower internal shoulders 284, 286 fixedly hold the product container 104 with respect to the body portion 262 of the shroud 260. As shown in FIG. 21, an inlet 288 of the actuator socket 264 is sized to accommodate the valve stem 142 of the product container 104. With the product container 104 thus installed within the shroud 260, the valve stem 142 is in contact with the actuator socket 264. However, in the present resting state the valve stem 142 is not depressed by the actuator socket 264, or depressed to a sufficient degree, to open the valve assembly within the product container 104. Preferably, the degree of pressure in the resting state should be sufficient to ensure that at all times a seal is maintained between the actuator socket 264 and the valve stem 142. Thus, the product container 104 is held axially within the shroud 260. Unwanted downward movement is prevented by the lower internal shoulders 286 and unwanted upward movement is prevented by the spring loading within the valve stem 142 and the upper internal shoulders 284. As the product container 104 is supported only at its mounting cup 132, containers 104 of different lengths can readily be accommodated in the same shroud 260. In the present embodiment, the shroud 260 is longer than the product container 104 inserted therein to illustrate that other, longer or shorter containers 104 can be placed within the shroud 260.

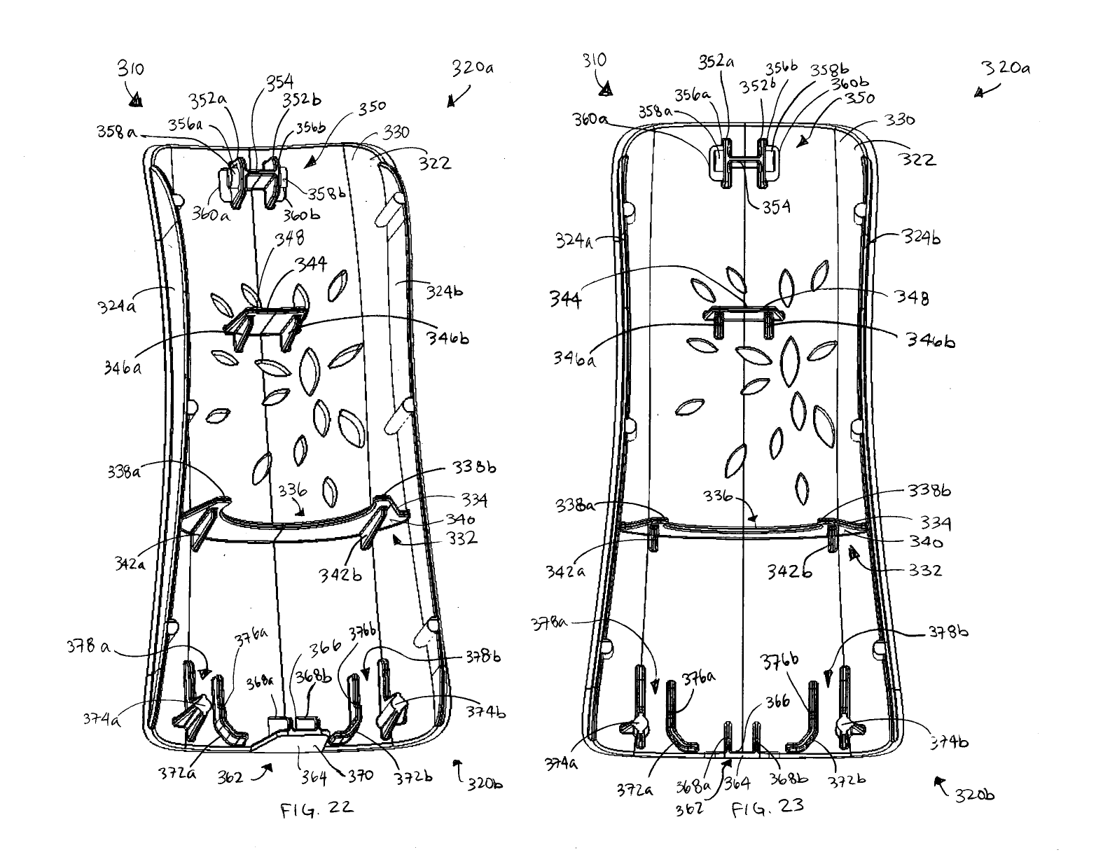

Turning now to FIGS. 25 and 26, the shroud 260 is utilized in an alternative dispensing system 300 that comprises a dispenser 302 configured to receive the product container 104 therein. It is contemplated that the alternative dispensing system 300 is similar to the dispensing system 100 described above, except for the differences noted herein. In one embodiment, the alternative dispensing system 300 is taller and wider than the previously described dispensing system 100 to fit variously sized product containers 104. The dispenser 302 provides a curvilinear housing 306 that comprises a front cover 308 attached to a rear cover 310 at a pivot joint 312 (see FIG. 26). The front and rear covers 308, 310 define an internal cavity 314 therebetween where the shroud 260 is received. In the present embodiment, the front cover 308 comprises a curved front wall 316 and a top cover 318 that extends transversely from the front wall 316 toward the rear cover 310 at an upper end 320a of the housing 306. The rear cover 310 comprises a curved rear wall 322 with a left wing 324a and a right wing 324b that extend toward the front cover 308 (see also FIG. 22). Turning again to FIG. 25, a front pattern 326a and a rear pattern 326b are disposed on the front and rear walls 316, 322, respectively, whereby each of the patterns 326a,b includes a blind hole, a through-hole, or various combinations thereof, as described below. The dispensing system 300 is activated by squeezing or rotating the front and/or rear covers 308, 310 together to depress the actuator socket 264 and the valve stem 142 of the product container 104 to release product from the container 104 through the top cover 318 of the front cover 308.

As shown in FIGS. 20-23, an inner face 330 of the curved rear wall 322 is adapted to receive the shroud 260 at a collar 332. The collar 332 includes a collar platform 334 that extends from the inner face 330 and includes portions defining a semi-circular cutout 336 (see FIGS. 22 and 23). The semi-circular cutout 336 is adapted to receive the shroud 260 about the exterior surface 276 of the cylindrical-shaped body portion 262 above the left and right shoulders 274a,b. The collar 332 secures and/or supports the shroud 260 by a snap-fit connection and may also provide structural integrity to the rear wall 334. Specifically, a pair of collar tips 338a,b (see FIGS. 20, 22 and 23) extend from distal portions of the collar platform 334 that define the semi-circular cutout 336 and provide a distance therebetween that is slightly less than the diameter of the body portion 262. In this case, the collar tips 338a,b and/or additional portions of the collar 332 or curved rear wall 322 temporarily resiliently deform during the insertion or removal of the shroud 260.

As further shown in FIGS. 22 and 23, an underside 340 of the collar 332 is provided with a pair of collar support ribs 342a,b that permanently join the collar 332 to the inner face 330. The width of the collar support ribs 342a,b may be shaped narrowly so as not to interfere with the left and right shoulders 274a,b of the shroud 260. It is noted that any number, size, shape, or configuration of collar support ribs 342a,b can be provided. In the present embodiment, the collar 332 is generally disposed within a lower half of the curved rear wall 322 and angled upwardly from the wall 322 to tilt the shroud 260 forwardly. As shown in FIG. 26, the collar 332 is adapted to facilitate in the positioning of the shroud 260 at an angle R away from the curved rear wall 322 and/or a support surface such as a wall so that the valve orifice 146 is also directed away from the rear wall 322 and/or support surface. It is contemplated that the angle R is similar to the angle A defined previously and may be generally characterized as not parallel to an axis defined by a support surface (generally referred to by axis C) or an axis defined by the rear wall 322 (see axis D). For instance, in some embodiments, the angle R is about 6 degrees to about 8 degrees.

Referring again to FIGS. 22 and 23, a standoff rib 344 projects from a portion of the inner face 330 with a pair of standoff supports 346a,b disposed therebelow to provide structural integrity to the rear wall 322. The standoff rib 344 is disposed above the collar 332 within an upper half of the rear wall 322 to also facilitate in the positioning of the shroud 260 away from the rear wall 332. In particular, as shown in FIG. 26, the standoff rib 344 extends farther into the internal cavity 314 than portions of the collar 332 projecting underneath it. In this manner, a forward edge 348 of the standoff rib 344 abuts the exterior surface 276 of the shroud 260. The standoff rib 344 is also angled upwardly from the axis D defined by the rear wall 322 in a similar fashion to the collar 332 and further spaces the shroud 260 from the rear wall 322.

With reference again to FIGS. 22 and 23, a hinge 350 is provided at the upper end 320a of the curved rear wall 322 to form a portion of the pivot joint 312 shown in FIGS. 26 and 27. It is contemplated that the pivot joint 312, and thus the hinge 350, is similar to the pivot joint 112 and the hinge 170 described previously. Particularly, the hinge 350 comprises a pair of fins 352a,b that are horizontally spaced apart by a fin support 354 disposed therebetween. Outer faces 356a,b of the fins 352a,b are provided with posts 358a,b, respectively, that are generally cylindrical structures adapted to be received in corresponding structures of the front cover 308 to form the pivot joint 312. Cutouts 360a,b are provided on the rear wall 322 behind the posts 358a,b to facilitate operation of the pivot joint 312.

Still referring to FIGS. 22 and 23, a tongue 362 disposed at the lower end 320b of the rear wall 322 is adapted to extend beneath the shroud 260. The tongue 362 comprises a tab 364 extending centrally from the lower end 320b of the rear wall 322. The tab 364 is a generally rectangular portion having a top side 366 provided with a pair of ridges 368a,b and a bottom side 370 that is generally flat. It is contemplated that the tab 364 guides the insertion of the shroud 260 and provides support in maintaining the upright position of the dispensing system 100 when placed on a support surface such a table. The tongue 362 also facilitates in other operational modes of the dispensing system 100, such as the mounted position, as described further below. Further, the tongue 362 is disposed between a pair of ridged ribs 372a,b, which are further disposed between a pair of support posts 374a,b. Each of the ridged ribs 372a,b provides a ridge 376a,b, as shown in FIG. 26, which is shaped to accommodate the angled deployment of the shroud 260 that results in the bottom end 290 of the shroud 260 projecting toward the curved rear wall 322. The ridged ribs 372a,b abut the bottom end 290 to provide support and prevent lateral and/or longitudinal movement of the shroud 260. Further, each of the support posts 374a,b operate as a support surface that the bottom end 290 of the shroud 260 rests upon. In the present embodiment, the support post 374a is spaced apart from the ridged rib 372a to define a channel 378a, and the support post 374b is spaced apart from the ridged rib 372b to define a channel 378b.

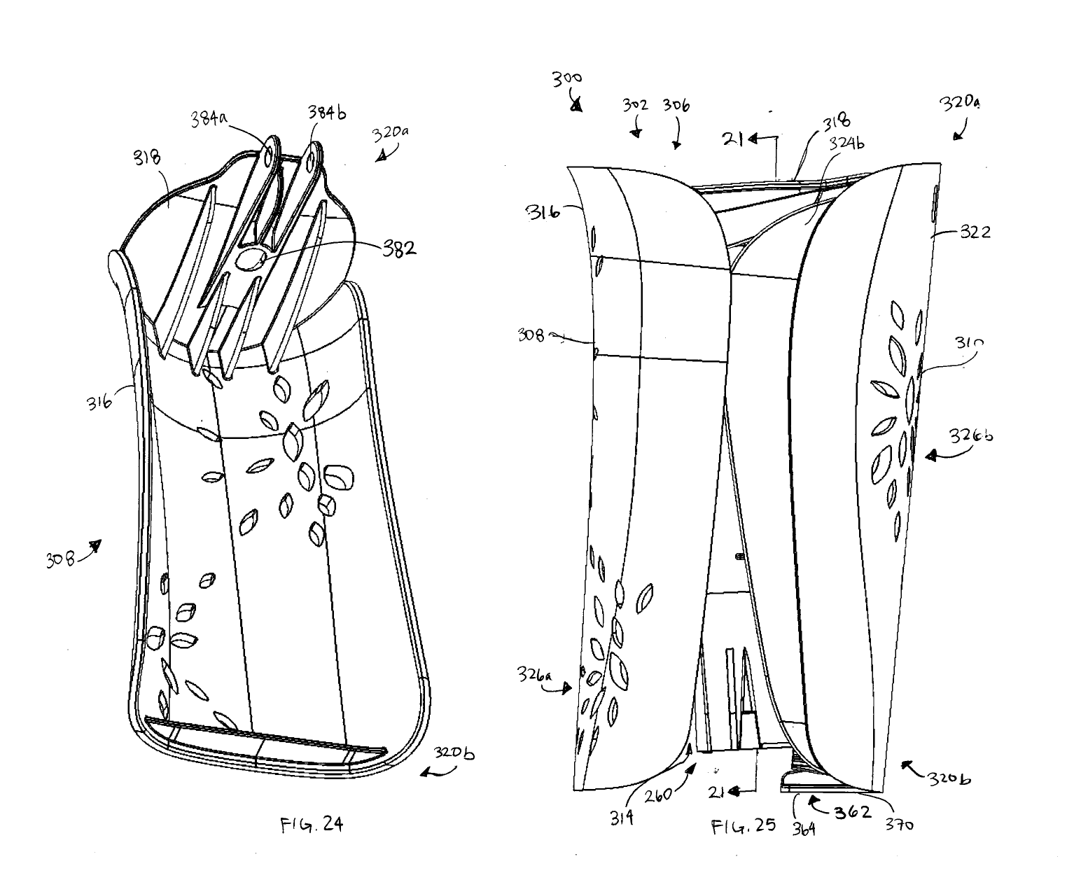

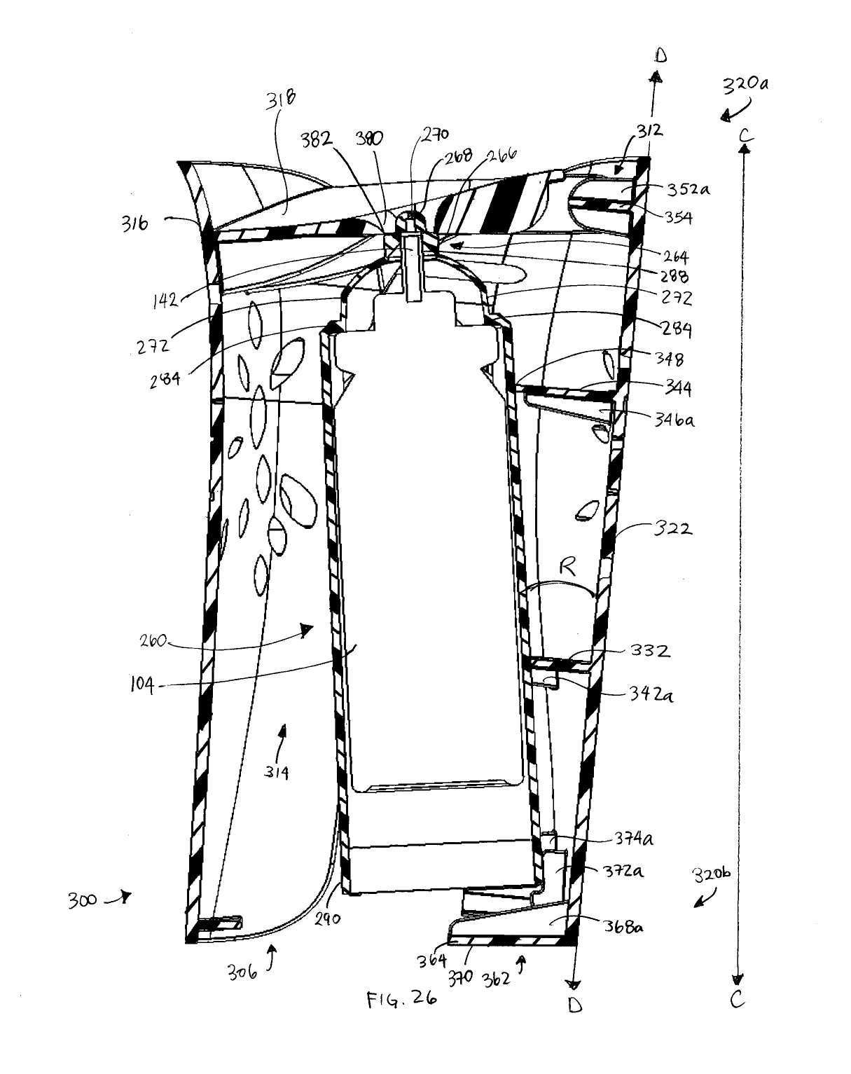

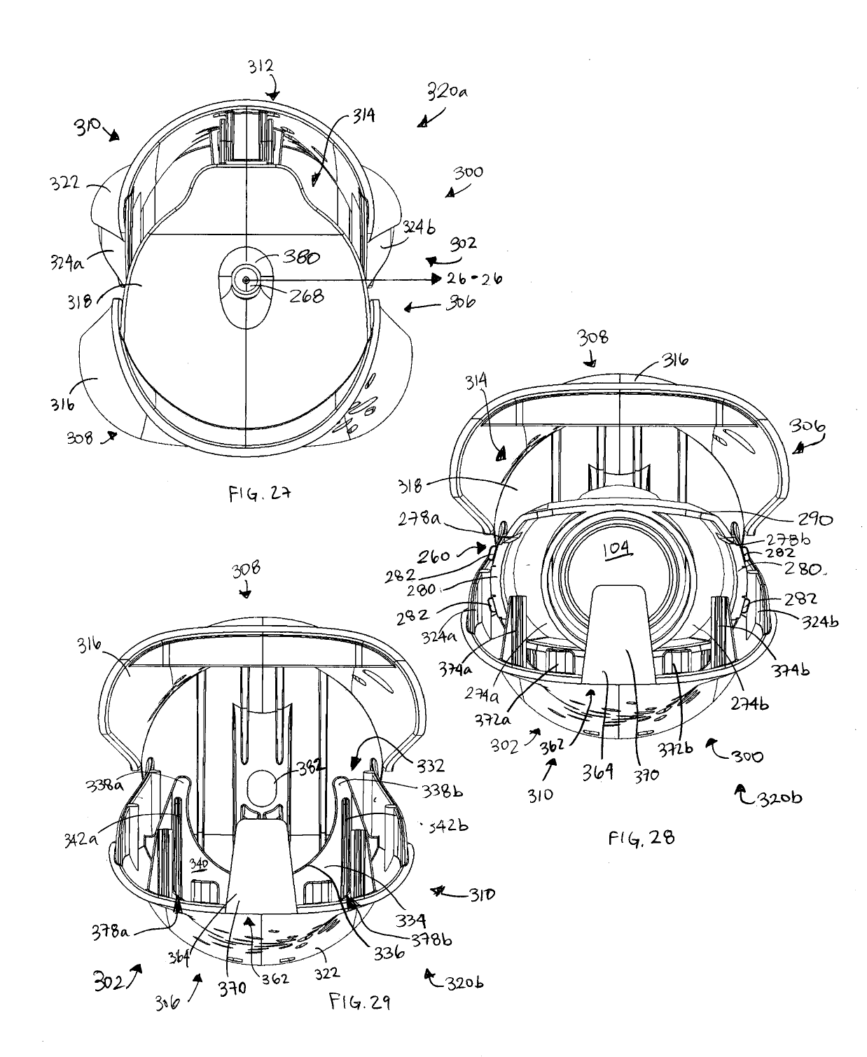

Turning now to FIGS. 24 and 25, the front cover 308 comprises the front wall 316 and the top cover 318, which extends generally transversely from the upper end 320a of the wall 316 toward the rear curved wall 310. The top cover 318 provides a discharge sink 380 surrounding a discharge orifice 382 for releasing the product therethrough (see FIGS. 26 and 27). It is noted that the front cover 308 is similar to the front cover 108 described above.

The front cover 308 is configured to be snapped to the rear cover 310 at the pivot joint 312, such that the dispensing system 300 operates in the same manner as the dispensing system 100. With reference to FIG. 26, it is contemplated that the actuator socket 264 is engaged to the discharge orifice 382 by abutment of the cylindrical receptacle 266 against surfaces defining the orifice 382 so that the bulbous end 268 extends through the discharge sink 380, either partially or fully. As shown in FIG. 24, the front cover 308 provides a pair of post orifices 384a,b that project from the top cover 318 for engaging the hinge 350 of the rear wall 322 (see FIG. 23). During an activation operation, the front and/or rear covers 308, 310 are squeezed or rotated together to cause the top cover 318 and/or the rear cover 310 to be forced downwardly and inwardly onto the actuator socket 264. In turn, the actuator socket 264 moves toward the product container 104 by way of the flexible members 272 to open the valve stem 142 and release the product. In another embodiment, for instance when the dispensing system 300 is wall-mounted, activation occurs by depressing the front cover 308 toward the rear cover 310, which provides an opposing force from a mounting wall behind it. Thus, the dispensing system 300 provides a triple-use dispenser 302 similar to the dispensing system 100 described previously, i.e., a variety of operating modes, including handheld, upright, and mounted position are possible.

Referring to FIGS. 25-29, the variety of operating modes will be further elaborated upon in connection with the dispensing system 300. It is contemplated that the user initially sets up the dispensing system 300 prior to operational deployment by slidingly inserting the product container 104 through the aperture 285 in the bottom end 290 of the body portion 262 of the shroud 260. The user stops the insertion of the container 104 when a snapping noise and/or force is perceived, which occurs when the mounting cup 132 is snapped between the upper and lower internal shoulders 284, 286 of the shroud 260. With the product container 104 secured therein, the shroud 260 is snapped into the collar 332 of the rear cover 310 and positioned such that the left and right shoulders 274a,b of the shroud 260 are disposed beneath the collar 332 and the bottom end 290 of the shroud 260 rests on the support posts 274a,b. With the shroud 260 thus secured to the rear cover 310, the front cover 308 can be snapped onto the rear cover 310 by connecting the post orifice 384a to the post 358b and the post orifice 384b to the post 358a, which together define the pivot joint 312. Alternatively, the front cover 308 can be snapped onto the rear cover 310 prior to insertion of the shroud 260 or it may preferably be already secured before a user must interact with it. Thereafter, the front cover 308 can be rotated upwardly about the pivot joint 312 to expose the inner face 330 of the rear cover 310 for insertion of the shroud 260. With the shroud 260 and the front cover 308 secured to the rear cover 310, the front cover 308 is rotated downwardly to a pre-operative position or rest state, whereby the discharge orifice 382 of the front cover 308 rests atop the actuator socket 264 of the shroud 260. In the present embodiment, the bulbous end 268 protrudes through the discharge orifice 382 and is circumnavigated by the orifice 382 and the discharge sink 380 of the front cover 308. In some embodiments, the actuator socket 264 is snapped into surfaces defining the discharge orifice 382 when the front cover 308 is rotated downwardly.

Referring back to FIGS. 9 and 14, it is noted that the dispensing system 100 is assembled in a similar fashion to the dispensing system 300, except that the mounting cup 132 of the product container 104 is snap-fit directly onto the collar 152 of the rear cover 110. In this case, the valve stem 142 can be inserted into the nozzle 208 before or after snapping the product container 104 into the collar 152. It is noted that the nozzle 208 may be provided integral with the front cover 108 and/or press-fit or otherwise secured to surfaces defining the discharge orifice 206. In one embodiment, it is contemplated that the nozzle 208 is snap-fitted into the discharge orifice 206, the front cover 108 is hingedly retained to the rear cover 110, the product container 104 is snap-fitted to the collar 152 of the rear cover 110, and then a downward rotational movement of the front cover 108 about the rear cover 110 aligns the nozzle 208 with the valve stem 142 to place the system in a rest or non-operative state. Preferably, a user must only hingedly rotate the front cover 108 about the rear cover 110 to allow for insertion of the product container 104 into the dispensing system 100 and its subsequent placement into a rest state when the front cover is rotated into a pre-operative position.

Turning back to FIGS. 25-29, upon assembly of the dispensing system 300, the dispensing system can be deployed in the upright position by engaging the lower end 320b against a flat surface, such as setting the system 300 on a table-top. The outwardly-flared lower end 320b of the curvilinear housing 306 provides a stable footprint for the standalone, upright positioning of the dispensing system 300. Further, in the present embodiment, the tongue 362, particularly the flat bottom side 370 of the tab 364, abuts the resting surface and contributes to overall stability (not shown). During the upright dispensing mode, the user squeezes the front and/or rear covers 308, 310 together to discharge the product from the product container 104. Upon activation, a plume of product is discharged at an angle upward and away from the rear cover 310, the angle of emission being dependent on the angle R that the shroud is offset from the rear cover 310, or the axis D defined by the rear cover 310, as shown in FIG. 26. Similarly, for the dispensing system 100 as shown in FIG. 14, the angle of emission is dependent on the angle A that the product container 104 is offset from the rear cover 110, which also defines the axis D.

Still referring to FIGS. 25-29, the user can grasp the dispensing system 300 for handheld operation. In particular, the dispensing system 300 is ergonomically designed similar to the dispensing system 100 described above to facilitate handheld use. It is contemplated that the dispensing systems 100, 300 are lightweight so as not to cause strain on the user's anatomy, e.g., their hand or wrist, when lifting and actuating the systems 100, 300. In the handheld position, the user applies a squeezing or rotational force to the front and/or rear covers 308, 310 to cause a spray of the product to occur. It is contemplated that front cover 308 is held facing away from the user, such that the angled plume of product does not project directly at the user.

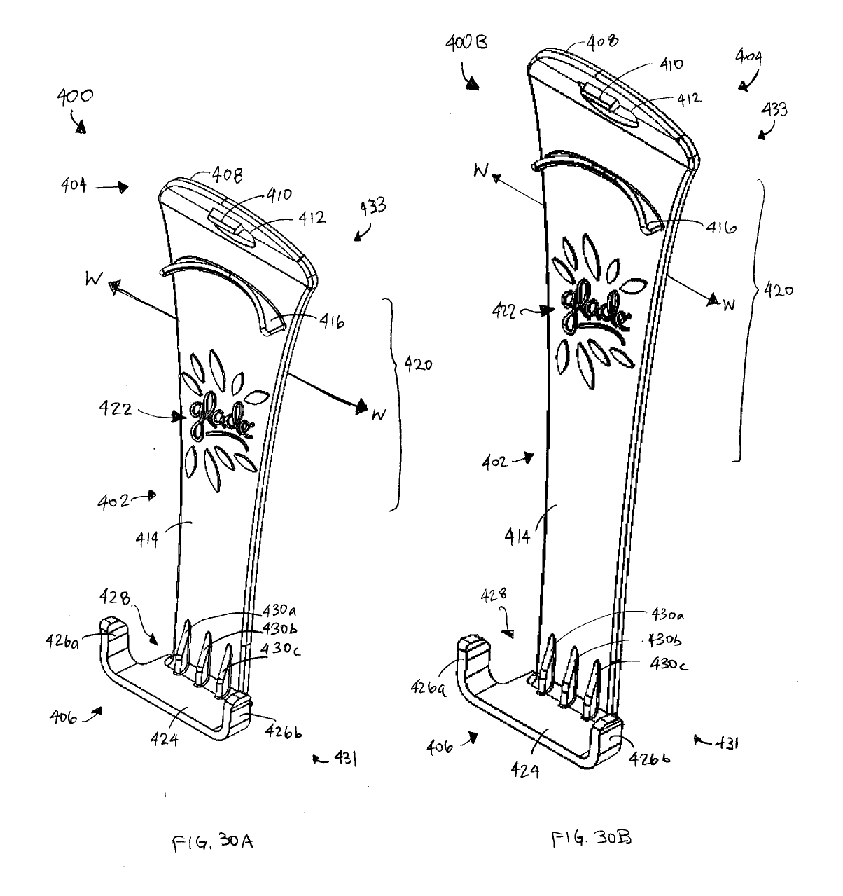

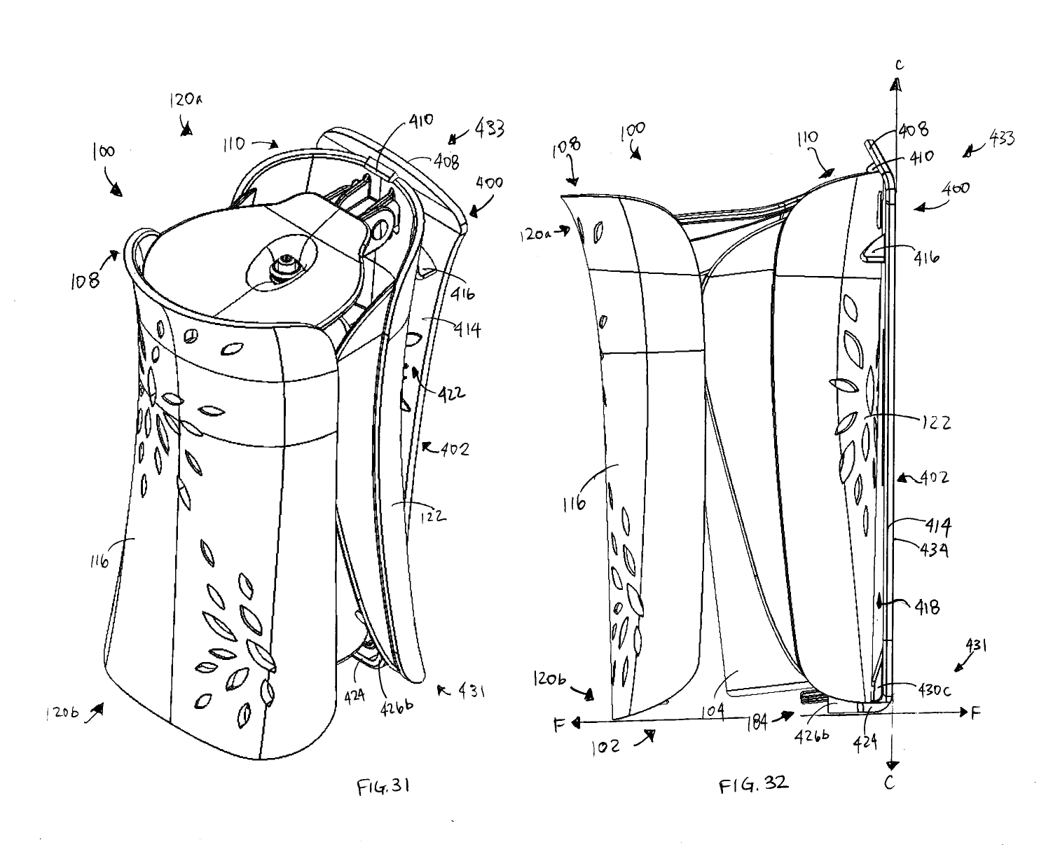

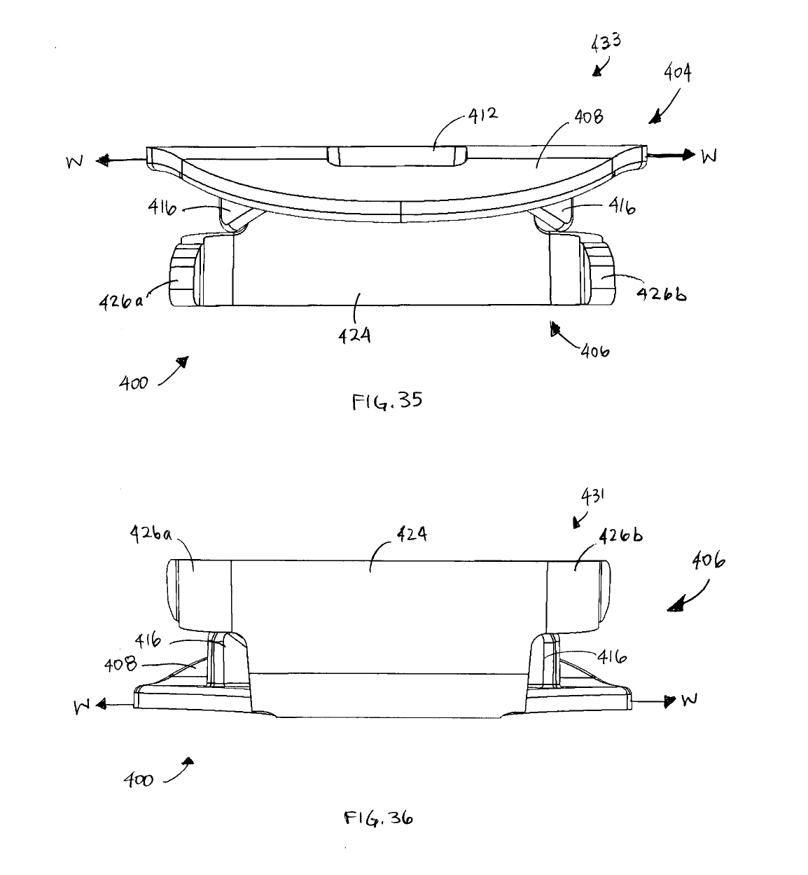

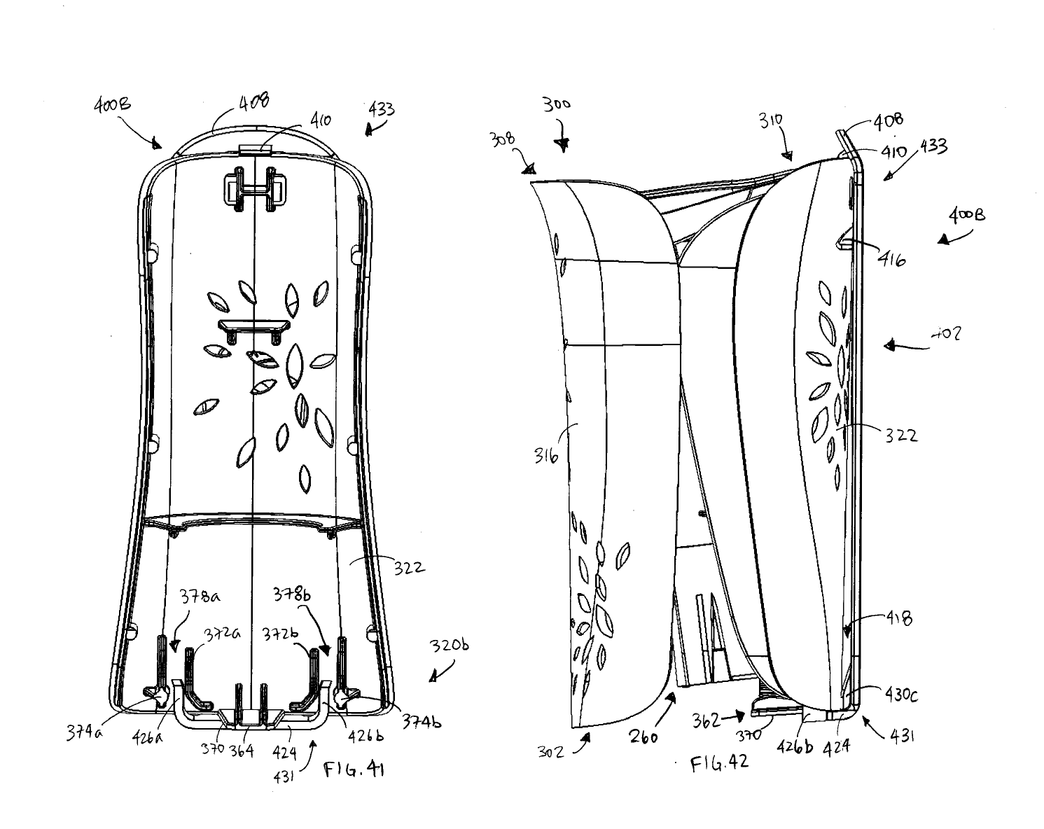

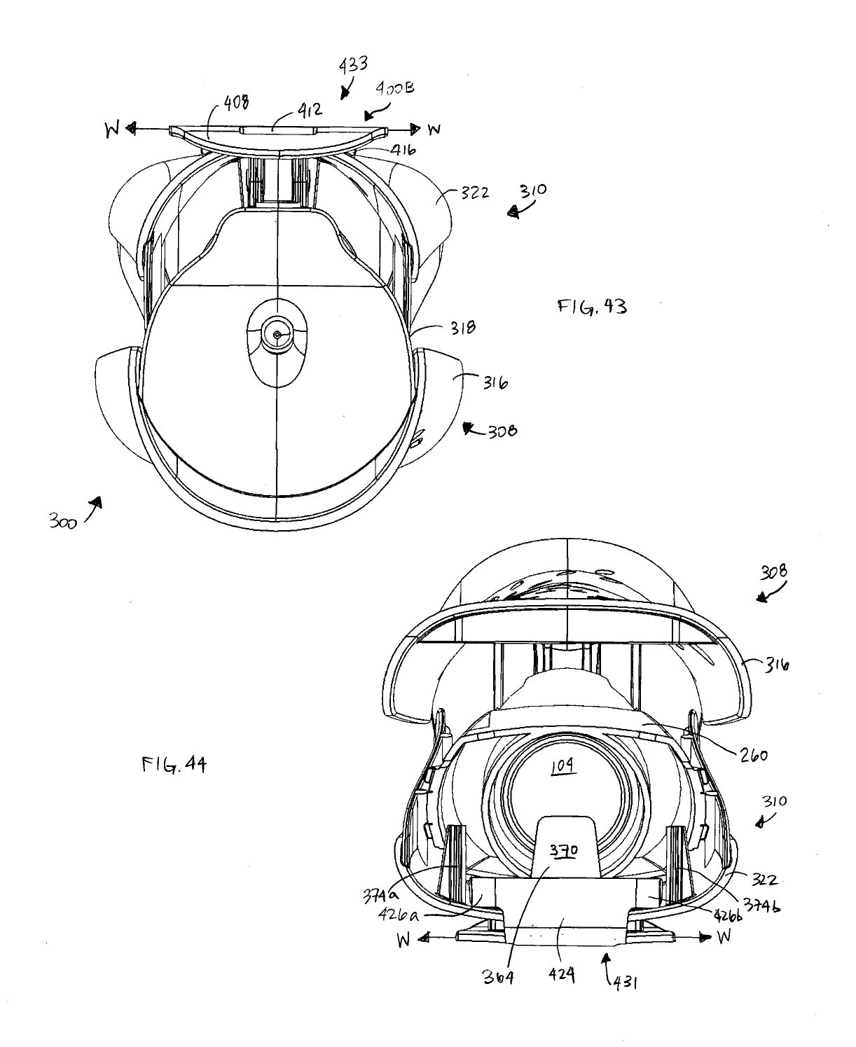

Turning now to FIGS. 30A-44, in a third mode of operation, the user can attach the dispensing systems 100, 300 to a mounting bracket 400 for storage and for actuating the dispensing system 100, 300 from a vertical surface. As shown in FIG. 30A, the mounting bracket 400 can comprise a plate, or elongate portion 402, that is adapted to be secured to a wall. The elongate portion 402 is flared upwardly toward a securing end 404 and narrows and straightens as it extends toward a resting end 406. The securing end 404 comprises a forwardly bent flap 408 having a snap element 410 that protrudes forwardly therefrom to snap over the upper end 120a of the rear cover 110 of the dispensing system 100. A mounting hole 412 is provided proximate the snap element 410 for hookingly receiving a nail, screw, hook, or other projection from the vertical surface (not shown) to engage the mounting bracket 400 thereto. In fact, any attachment means may be used to secure the mounting bracket to a surface, e.g., an adhesive or any other connection means as known to one of skill in the art. In the present embodiment, the mounting hole 412 is provided beneath the snap element 410 so that when the dispensing system 100 is deployed on the bracket 400, the functionality of the hole 412 and its engagement to the vertical surface is hidden behind the dispensing system 100 for aesthetic purposes. It is contemplated that the elongate portion 402 is a straight and flat structure that defines a plane W, which is parallel to the vertical mounting surface such that the elongate portion 402 is configured to flushly align against the vertical surface.

Still referring to FIG. 30A, a front surface 414 of the elongate portion 402 is provided with a curved standoff rib 416 that interfaces with the rear cover 110. The curved standoff rib 416 is preferably complementary to the curvature of the rear cover 110 and facilitates in the snap-in assembly thereof by defining a longitudinal gap 418 between the rear cover 110 and the elongate portion 402 (see FIG. 32). The longitudinal gap 418 also facilitates the operation of the mounting hole 412 whereby a nail, screw, hook or other projection may extend through the hole 412 toward the rear cover 110. Further, the curved standoff rib 416 brings the front surface 414 into geometric conformity with the curvature of the curved rear wall 122, which is flared at the upper and lower ends 120a,b. Even further, the curved standoff rib 416 contributes to side-to-side stability of the dispenser 102 when mounted thereon. With reference to FIGS. 30A and 30B, the curved standoff rib 416 is disposed on the flared upper half 420 of the elongate portion 402 proximate the forwardly bent flap 408. The front surface 414 of the elongate portion 402 can further be provided with surface treatments 422, such as decorative and/or informative indicia, shapes, insignias, logos, and the like, that are imprinted, indented, painted on or cut through the portion 402.

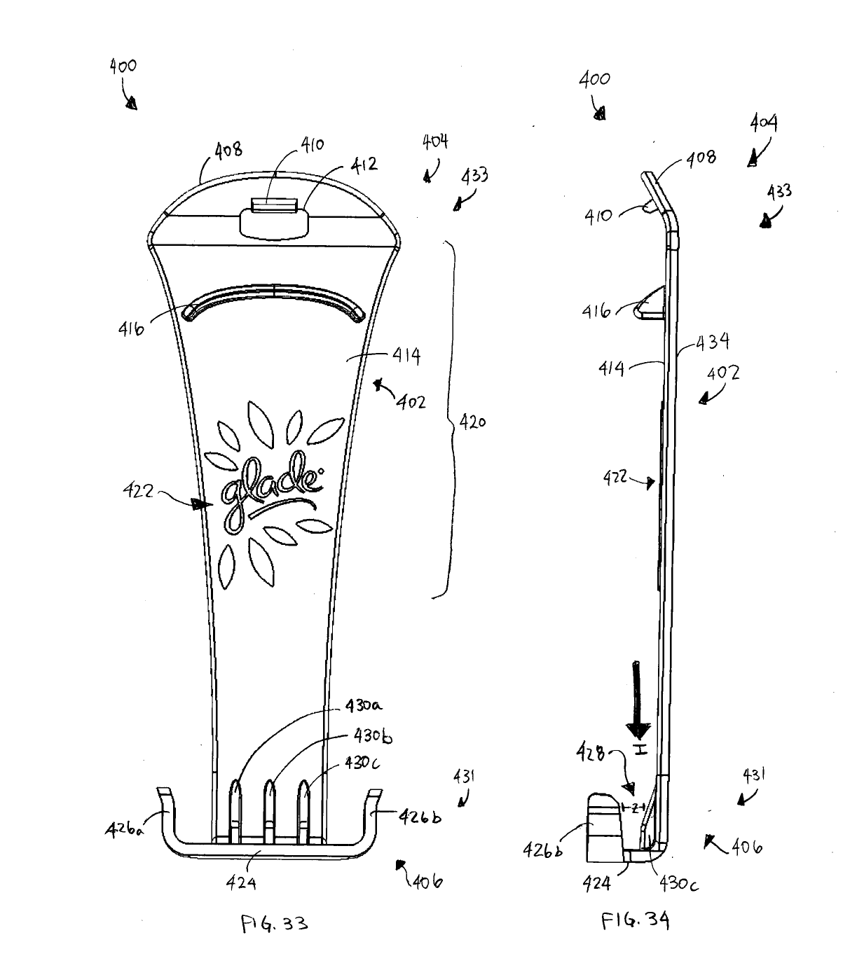

The resting end 406 comprises a horizontally-disposed shelf 424 with a left prong 426a and a right prong 426b extending upwardly from the left and right sides of the shelf 424. The left and right prongs 426a,b are positioned distal to the elongate portion 402 to define a slot 428 therebetween. The slot 428 is adapted to guide and receive the rear cover 110 into a resting position on the shelf 424. The shelf 424 is further provided with a plurality of parallel ribs, such as tapered spacer ribs 430a-c, which in the present embodiment include portions within the slot 428. The spacer ribs 430a,b,c facilitate in guiding and positioning the rear cover 110 onto the shelf 424 by bringing the geometry of the slot 428 into conformity with the curvature of the curved rear wall 122. In particular, the spacer ribs 430a,b,c interface with the lower end 120b of the curved rear wall 122 that rests on the shelf 424. As shown in FIG. 34, the slot 428 decreases in width Z in an insertion direction I moving downwardly toward the shelf 424, due in part to the tapered geometry of the spacer ribs 430a,b,c. It is noted that although three spacer ribs 430a,b,c, are shown, any number of ribs can be utilized. In one embodiment, at least two parallel ribs or spacer ribs extend between a lower end 431 and an upper end 433 of the elongate portion 402. In one embodiment, it is contemplated that the snap element 410 is provided adjacent the upper end 433 of the elongate portion 402 and above the spacer ribs 430a,b,c and the standoff rib 416.

Turning now to FIGS. 31, 32, 37, and 38, the mounting bracket 400 is shown deployed on the dispensing system 100. In one embodiment, the lower end 120b of the rear cover 110 is inserted into the slot 428 and restingly engages the shelf 424 and the upper end 120b of the cover 110 is snap-fit to the mounting bracket 400 by the snap element 410. As such, the snap-fit connection at the upper end 120b retains the dispenser 102 on the mounting bracket 400 while the lower end 120b rests on the shelf 424. It is contemplated that the snap element 410 and/or forwardly bent flap 408 temporarily resiliently deform over the top end 120a of the rear cover 110 during the snap-on or snap-off thereof. The snap-in mechanism further provides a user indication, such as a click noise, that the dispenser 102 is fully secured to the mounting bracket 400. In one embodiment, to facilitate the connection of the mounting bracket 400, the rear cover 110 is less curved or flared than the front cover 108 to further provide a secure, tight fit when placed on the mounting bracket 400. In another embodiment, it is contemplated that the dispensing system 100 is integrally formed with one or more mounting holes (not shown) on the rear cover 110, such as a nail or screw hole that allow for securement to a vertical surface. In other embodiments, other securement mechanisms known to one of skill in the art may be employed to hold the dispensing systems 100, 300 onto a support surface.

As shown in FIGS. 37, 39 and 40, the mounting bracket 400 is shown engaging the rear curved wall 122. The snap element 410 snaps over the upper end 120a of the rear curved wall 122 at the securing end 404. The shelf 424 and the prongs 426a,b extend about the lower end 120b of the rear curved wall 122 at the resting end 406. In particular, the prongs 426a,b are disposed adjacent (either in abutment or near to) outer sides 432a,b, respectively, of the U-shaped rib 186 (see FIG. 37). Further, the prongs 426a,b are also disposed adjacent (either in abutment or near to) the inner face 150 of the rear curved wall 122. The prongs 426a,b prevent, or significantly prevent, lateral and forward movement of the dispenser 102. It is contemplated that at least two prongs are provided on the shelf 424. In one embodiment, the tongue 184 of the rear curved wall 122, and particularly the bottom side 194 of the tab 188, rests on the shelf 424 and provides additional stability. It is noted that even with the mounting bracket 400 deployed on the dispenser 102, the dispensing system 100 can be placed in the upright position on a flat surface. As shown in FIG. 32, the rear cover 110 is elevated above a flat resting surface F due to the thickness of the shelf 424, such that the dispenser 102 may tilt forwardly. Similarly, the dispenser 102 is angled slightly forwardly when the mounting bracket 400 is positioned flushly against the vertical surface of a support wall that defines the axis C.

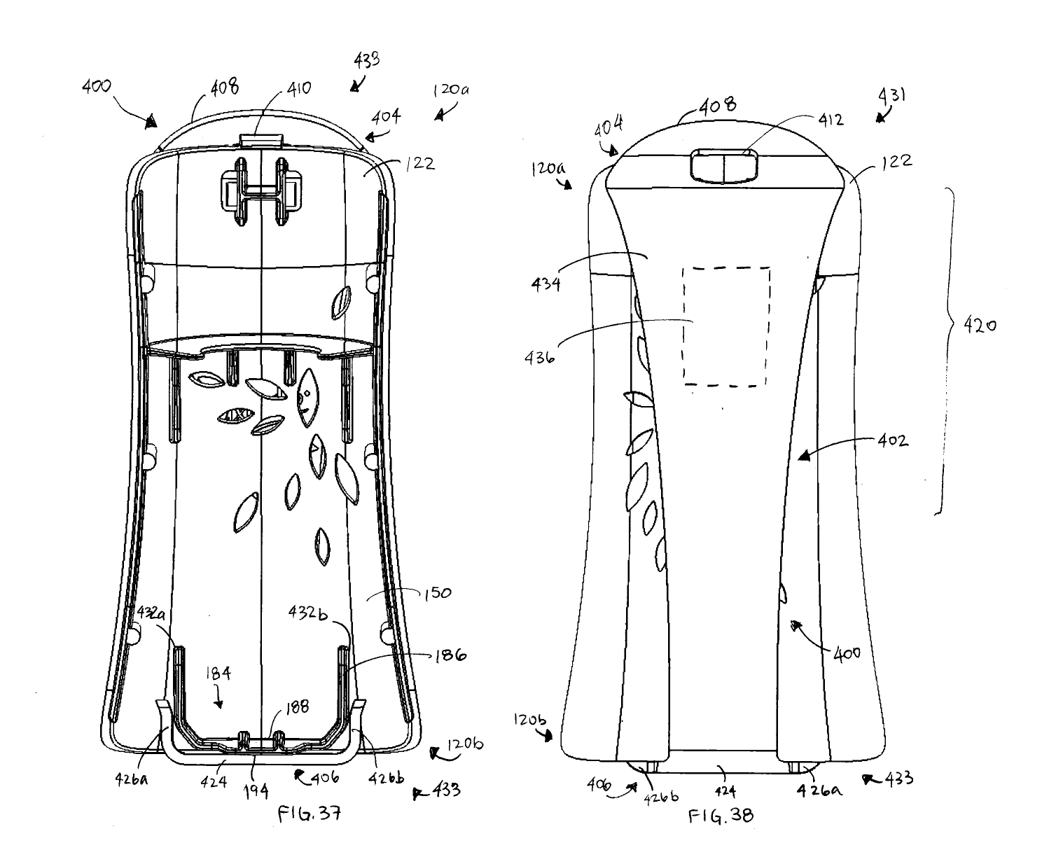

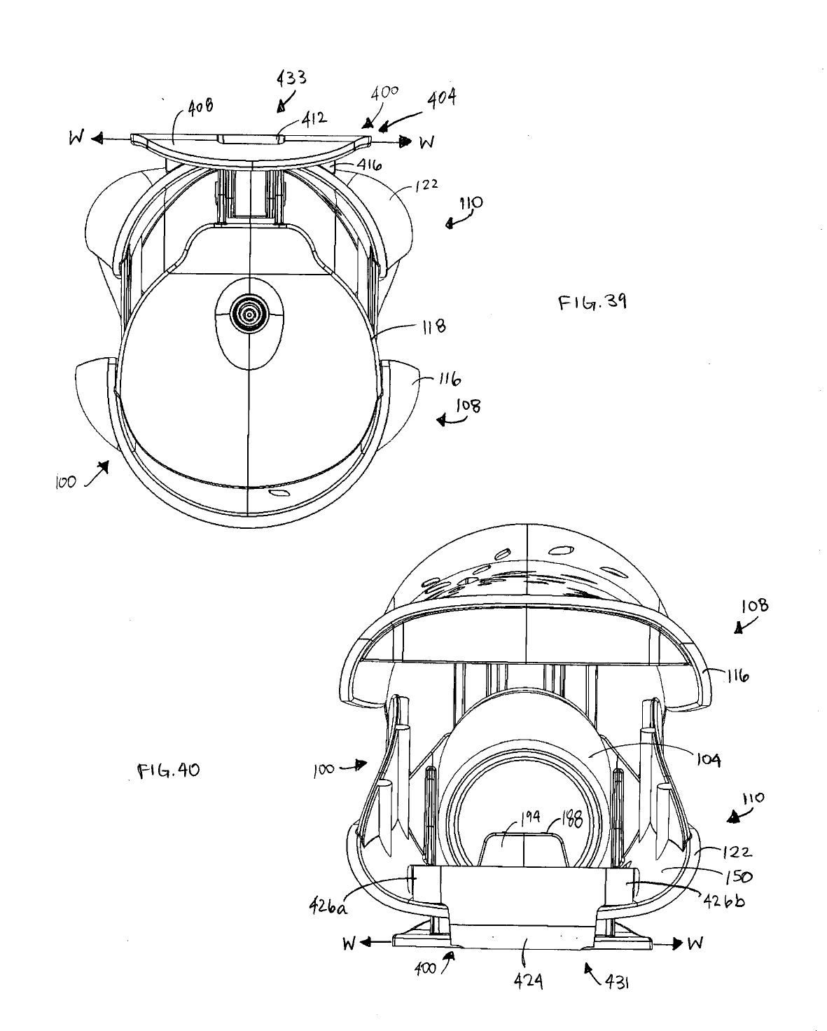

Turning now to FIG. 38, a back surface 434 of the elongate portion 402 is shown, with the dispensing system 100 mounted to the opposing front surface 414 (not visible). It is contemplated that the back surface 434 is smooth and flat to so that it rests against a vertical mounting surface. In another embodiment, the back surface 434 has at least one inset 436 that is an indented portion to facilitate application of adhesives, such as double-sided tape, or other mounting means.

Referring to FIGS. 30B and 41-44, another embodiment of a mounting bracket 400B having a different size than the mounting bracket 400 is shown. In particular, the mounting bracket 400B is sized according to the dispensing system it accommodates, such that the elongate portion 402 is shortened or lengthened to conform with the height of the dispenser secured thereto. It is noted that the mounting bracket 400B is provided to illustrate that the mounting bracket 400 can be scaled up or down in size.

As shown in FIGS. 41-44, the mounting bracket 400B is mounted onto the dispensing system 300. It is contemplated that the dispensing system 300 is larger in size than the dispensing system 100 and that the mounting bracket 400B is an enlarged version of the mounting bracket 400 with similar reference numerals provided for similar structure. As such, it is contemplated that the mounting bracket 400B receives the dispensing system 300 in a similar fashion as that of the mounting bracket 400, except for the differences noted herein. In particular, the prongs 426a,b are positioned within the channels 378a,b at the lower end 320b of the rear curved wall 322 (see FIG. 41). It is contemplated that the ridged ribs 372a,b and the support posts 374a,b that together define the channels 378a,b guide the insertion of the curved rear wall 322 onto the shelf 424. Further, the supports posts 374a,b and ridged ribs 372a,b that define the channels 378a,b also provide side-to-side and forward-to-backward stability of the dispenser 102 by restraining lateral movement of the curved rear wall 122 completely or within predefined margins of movement. Further, the bottom side 370 of the tab 364 that extends outwardly from the rear curved wall 322 rests atop the shelf 424 to provide additional stability during actuation in the vertical position.

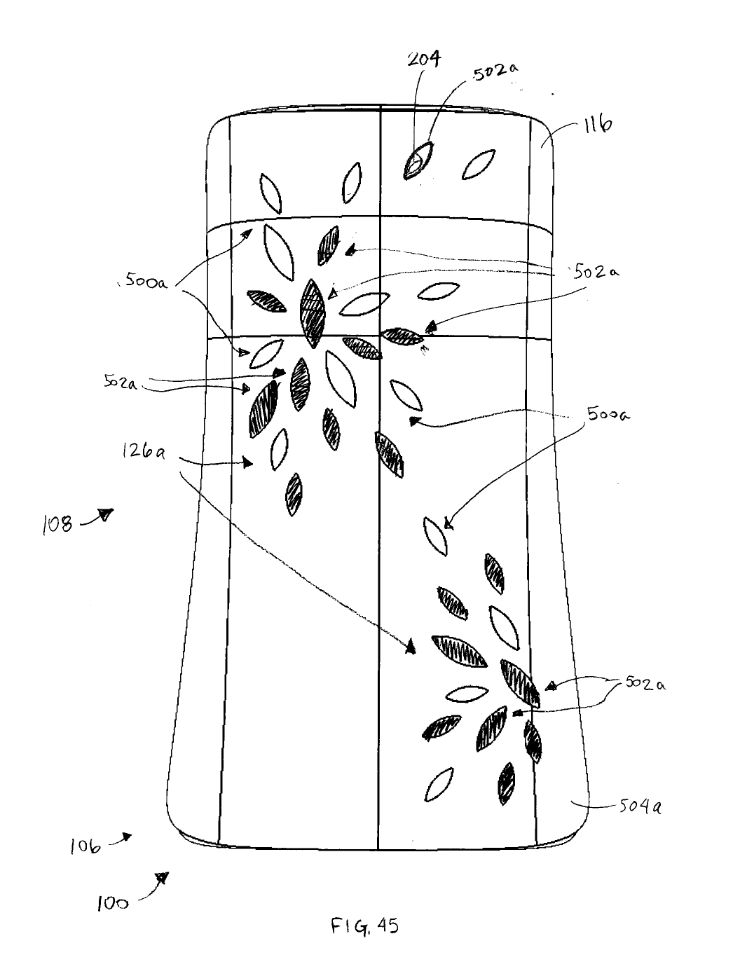

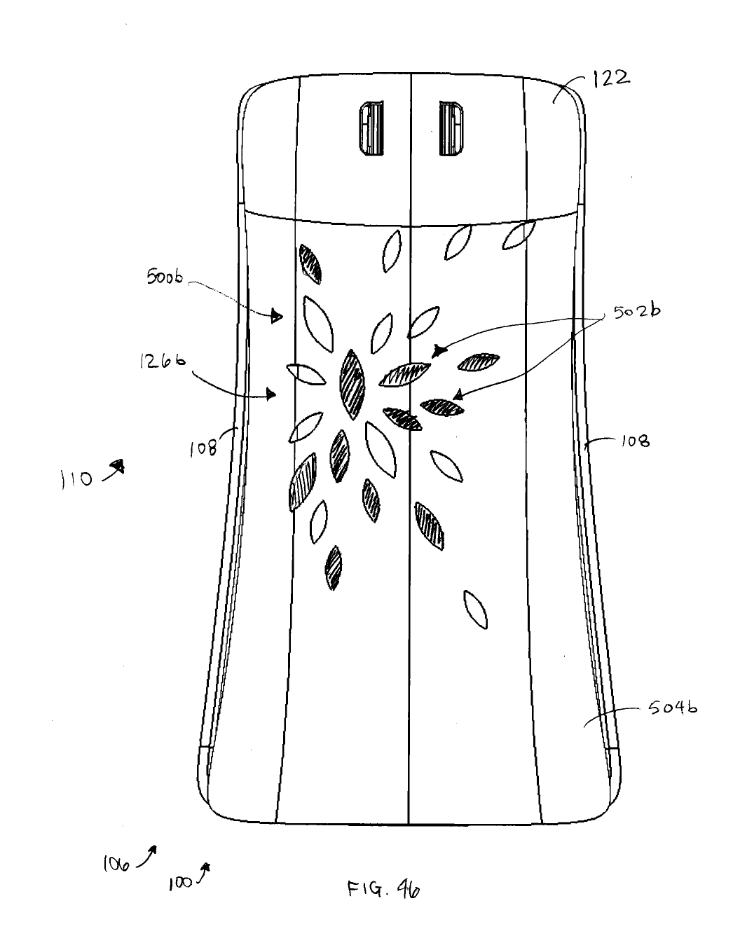

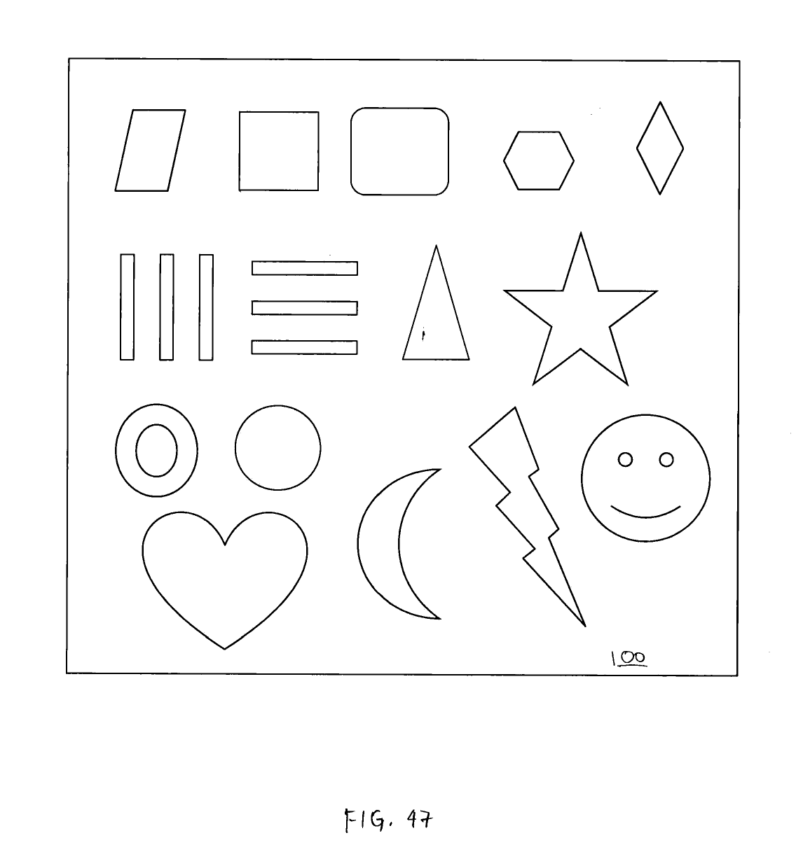

Turning now to FIGS. 45-48, it is contemplated that aesthetics are an important aspect in maximizing user benefit of the dispensing systems 100, 300. The aesthetics will hereinafter be described in relation to the dispensing system 100, which is further representational of the dispensing system 300. As shown in FIGS. 45 and 46, the front and rear covers 108, 110 of the housing 106 are provided with the front and rear patterns 126a,b, respectively. In particular, the curved front wall 116 and the curved rear wall 122 are provided with the front and rear patterns 126a,b, respectively, although any portion of the housing 106 can have patterns disposed thereon.

Each of the front and rear patterns 126a,b comprises at least one decorative recessed portion, hereinafter referred to as a decorative recession 500a,b, respectively, within the front and rear patterns 126a,b that does not extend entirely through the respective wall 116, 122. Further, each of the front and rear patterns 126a,b comprises at least one decorative aperture, hereinafter referred to as a decorative aperture or an aperture 502a,b, respectively, within the front and rear patterns 126a,b that does extend completely through the wall 116, 122. Therefore, each decorative recession 500a,b is a blind hole that does not extend completely through the housing 106 while each aperture 502a,b extends through the housing 106 to the internal cavity 114. Both the decorative recessions and the apertures 502a,b may be broadly characterized as interruptions within the surface of the housing and, more particularly, the front and rear walls 116, 122. It is contemplated that the combination of the front decorative recessions 500a and the front apertures 502a add depth and color contrast to the front cover 108. Similarly, the combination of the rear decorative recessions 500b and the rear apertures 502b add depth and color contrast to the rear cover 110. In particular, the placement and configuration of the front and rear apertures 502a,b, which may be positioned about the front and rear decorative recessions 500a,b, respectively, create a pronounced and visible lighting contrast between the through-hole apertures and the blind hole recesses, as well as between interrupted and uninterrupted portions of the housing 106. Thus, such a visible contrast within the housing 106 may be alterable with the configuration of the front and rear patterns 126a,b.

As shown in FIG. 45, for example, a plurality of decorative recessions 500a and a plurality of apertures 502a are positioned about the curved front wall 116. In the present embodiment, the front decorative recessions 500a and the front apertures 502a appear similar in shape and size, but different in orientation. It is noted that the depth of each front decorative recession 500a can vary within each recession 500a or compared to other recessions that are blind holes. The plurality of front decorative recessions 500a are leaf-shaped and provided within an outer surface 504a of the front cover 108. Further, the plurality of front decorative recessions 500a are dispersed among the plurality of front apertures 502b to achieve variations in the light contrast from the housing 106. For instance, it is contemplated that the front apertures 502a appear darkest, because photons of light traveling through the apertures 502a enter the internal cavity 114 and do not bounce back sufficiently to be perceived. On the other hand, the uninterrupted portions of the front outer surface 504a appear the lightest, since photons hitting the surface 504a are reflected back toward the user. Finally, the front decorative recessions 500a appear intermediate in lightness due to the depth of the recessions that cast shadows and occlude some photon reflection. In one embodiment, the front outer surface 504a is visually perceived as white colored, the front decorative recessions 500a appear gray, and the front apertures 502a appear black. However, any number of light and color gradations are possible based on the materials used to make the housing 106 as well as the coloration or finish of the housing.

In a different embodiment, the perceived surface texture or finish of the front outer surface 504a can be visually altered. For instance, the front outer surface 504a may be provided black, but given the high reflectivity of light from the surface 504a, the outer surface 504a appears shiny. In contrast, the front apertures 502a appear matte black due to its lack of surface reflection. Further, the front decorative recessions 500a, which may also be provided in black, appear intermediate between shiny and matte, when viewed in conjunction with the surrounding front decorative recessions 500a and the front outer surface 504a.

Therefore, it is contemplated that a color contrast or perceived texture or finish of the housing 106 are alterable by the provision of the combination of front decorative recessions 500a, front apertures 502a, and portions of the outer surface 504a that are uninterrupted. It is contemplated that the effect can be further altered by varying the depth of the front decorative recessions 500a to change the shades of gray perceived therein and/or the shiny or matte quality of the front cover 108. For instance, a shallower recession may appear shinier and/or lighter in color than a deeper recession due to its higher reflectance of photons.

Referring again to FIGS. 45 and 46, it is noted that the rear decorative recessions 500b, the rear apertures 502b, and the rear outer surface 504b of FIG. 46 can be described in a similar fashion as those of the front in FIG. 45.

The front and rear patterns 126a,b therefore contribute in many ways to the 360 degree all-around aesthetic qualities of the dispensing system 100 by creating a more visually interesting dispenser 102 having a variety of different discernible colorations and perceived textures and finishes, which naturally encourages the user to pick up the dispenser 102 to use it. It is noted that the front and rear patterns 126a,b shown in FIGS. 45 and 46 are non-limiting, and the patterns 126a,b can be non-mirrored or mirrored and similar or different in design. Further, other portions of the housing 106 can be provided with patterns, e.g., the left and right sides and the top and bottom of the housing 106. In one embodiment, the housing 106 includes at least one decorative recession 500 and/or at least one decorative aperture 502 on one or more of the housing 106 or the front and rear covers 108, 110 or the front and rear walls 116, 122. In another embodiment, one or more of the housing 106 or the front and rear covers 108, 110 or the front and rear walls 116, 122 includes a plurality of decorative recessions 500 and/or a plurality of decorative apertures 502.

Referring yet again to FIGS. 45 and 46, it is contemplated that although seemingly infinite configurations of the front and rear patterns 126a,b can be provided, in operation the quantity of front and rear apertures 502a,b must be balanced with the structural integrity of the dispenser 102. For instance, too many interruptions disposed on the front cover 108, whether blind holes, recessions, apertures or combinations thereof, can compromise the structural integrity of the front cover 108. In this case, the front cover 108 may wear out and break under normal bending forces. As such, it is contemplated that a surface of the housing 106 is not disposed entirely with recessions and apertures, and further, the size and placement of such interruptions may optimized to best maintain the structural integrity of the housing 106 while still providing aesthetically pleasing qualities. As shown in FIG. 45, in one embodiment the curved front wall 116 comprises a majority of non-interrupted surface area NI forming the front outer surface 504a. The total interrupted surface area I, consisting of both the front decorative recessions 500a and the front apertures 502a, comprises about 5% to about 40% of the curved front wall 116. In another embodiment, the total interrupted surface area I comprises about 10% to about 30% of the curved front wall 116. In yet another embodiment, the total interrupted surface area I comprises about 25% of the curved front wall 116. Further, a ratio R of the total interrupted area I to the non-interrupted surface area NI of the curved front wall 116, R=I/NI, is about 1:4 to about 2:5. In another aspect, the ratio R is about 1:3. It is noted that the ratio R does not exceed 1.

As shown in FIG. 46, the curved rear wall 122 and the pattern 126b disposed thereon can be described in a similar fashion to the curved front wall 116 of FIG. 45. As such, the curved rear wall 122 shows an alternative distribution of interrupted and non-interrupted surface areas that may be applicable to the curved front wall 116 as well. It is contemplated that none of the configurations of patterns 126a,b illustrated herein are intended to be limiting. In one embodiment, the curved rear wall 122 comprises a majority of non-interrupted surface area NI on the rear outer surface 504b. The total interrupted surface area I, consisting of both the rear decorative recessions 500b and the rear apertures 502b, comprises about 5% to about 20% of the curved rear wall 122. In another embodiment, the total interrupted surface area I comprises about 10% to about 15% of the curved rear wall 122. In yet another embodiment, the total interrupted surface area I comprises about 10% of the curved rear wall 122. Further, a ratio R of the total interrupted surface area I to the non-interrupted surface area NI of the curved rear wall 116, R=I/NI, is about 3:20.

Turning now to FIG. 47, it is contemplated that the recessions and apertures disposed on the housing 106, such as the front and rear decorative recessions 500a,b and the front and rear apertures 502a,b, can have a plurality of geometric shapes and designs. Similarly, it is contemplated that the front and rear patterns 126a,b can be formed in various patterns as well. For instance, recessions, apertures, and patterns can be shaped as a plurality of horizontal grills, curved lines, or other geometries. It is contemplated that various patterns such as soft curves, radii, blossom patterns, and other natural shapes may be formed to improve the feel and tone delivered in viewing the dispenser 102. Further, it is contemplated that the front cover 108 and the rear cover 110 can provide different themes of designs in order to provide different looks and feels for the user to selectively display. Merely by way of example, the front cover 108 can have aesthetic designs of summer motifs while the rear cover 110 provides an autumnal theme, such that the user can select different display themes that transition through the seasons. As shown in the schematic diagram of FIG. 47, a plurality of shapes and designs can be contemplated for the front and rear decorative recessions 500a,b, the front and rear apertures 502a,b, the front and rear patterns 126a,b, and/or any other recessions and apertures disposed on the housing 106. In the non-limiting example of FIG. 47, the dispensing system 100 can have various aesthetic elements in form of rectangular shapes, trapezoids, diamonds, horizontal and vertical grills, triangles, stars, donut-shapes, hearts, circles and ovals, smiley faces, moons and lightening, and the like, which can be selected depending on the demographics of the targeted users.

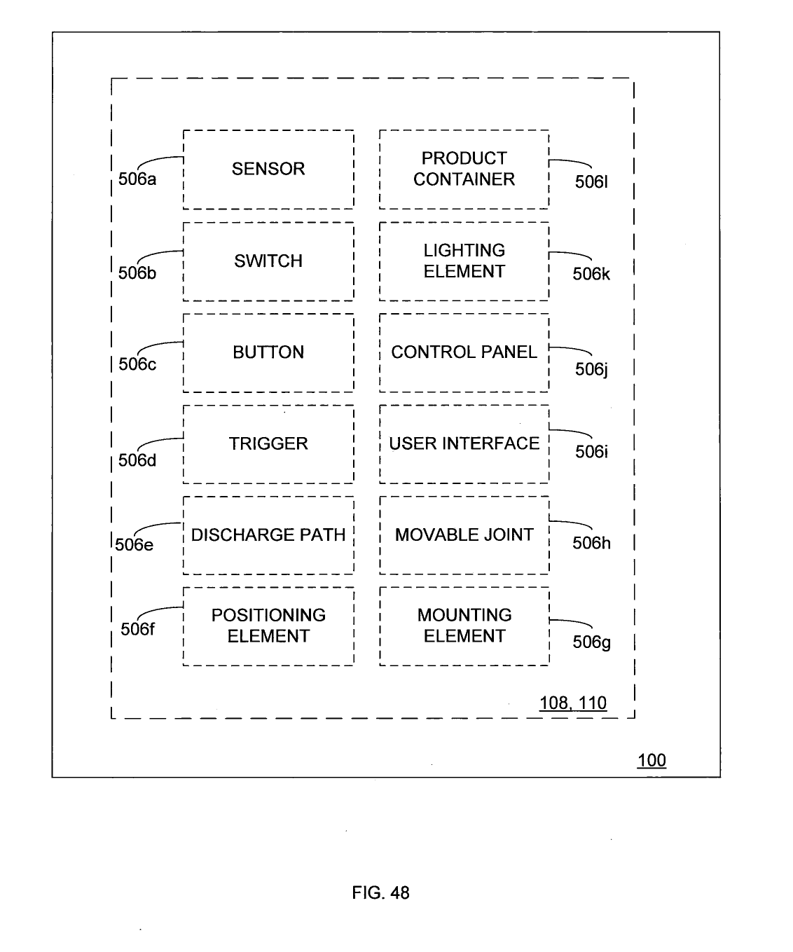

Turning now to the schematic diagram of FIG. 48, it is contemplated that the dispensing system 100 comprises at least one functional aperture 506a-1, also known as optional apertures, disposed within the housing 106, e.g., on the front and/or rear covers 108, 110. In particular, the term functional aperture is herein defined as an aperture that is provided for allowing either mechanical or electrical input or output from, into, or through the aperture to effect a functional activity of the dispensing system 100 in one or more of the three modes of operation disclosed herein. In contrast, non-functional apertures are herein defined as apertures that do not effect the operational aspects of the dispensing system 100. For example, a non-functional aperture 508 can be a front or back aperture 502a,b that is provided in conjunction with the front and/or back pattern 126a,b for aesthetic purposes only. On the other hand, an aperture that extends through the front or back covers 108, 110 is a functional aperture 506 if it serves a functional activity in operating the dispensing system 100 as noted above, even though it may also contribute to the aesthetics of the device.

As shown in FIG. 48, various functional apertures 506a-1 are provided, although the list of functional apertures 506a-1 is not intended to be limiting. In one embodiment, the functional aperture 506a is an aperture or hole that facilitates operation of a sensor, such as a sensor port, that detects environmental conditions and/or objects or people. The sensor may be able to detect the stimuli or environmental condition as it passes through the functional aperture 506a or by the sensor extending wholly or partially therethrough. Sensors may be used to trigger a particular mode of the dispensing system 100, e.g., an actuation mode, or any other functional aspect of the dispensing system 100, which may be manual and/or automatic. The sensor may comprise any type of sensor as known to those of skill in the art, of which a non-exclusive list of sensors includes light sensing elements, such as photodetectors, photodiode light detectors, photoresistors, photodiodes, or phototransistors; passive infrared sensors; motion sensors; acoustic sensors; humidity sensors; temperature sensors; pressure sensors or contact switches; vibration sensors; accelerometers; chemical or scent sensors; ultrasonic motion sensors; a radio or microwave radio motion sensor; or audio sensors. Further, the sensor can be replaced or used in combination with any other type of sensor known to those skilled in the art.

In another embodiment, the functional aperture 506b is provided on the housing 106 for a switch to extend wholly or partially therethrough. In other embodiments, the aperture 506b may allow a user or other means to extend through the aperture to activate the switch. For example, the switch may turn the dispensing system 100 on or off or change an operating parameter of the dispensing system 100. Similarly, the functional aperture 506c may expose a button, which may be used to effect any number of functional undertakings, such as manual spraying or a locking or unlocking of an actuation mechanism or the housing 106. The functional aperture 506d may provide access to a trigger and/or other functional elements of the dispensing system 100 to actuate the dispensing system 100. The functional aperture 506e may further provide a path of egress for a discharged product. Further, it is noted that the functional apertures 506a-1 need not extend toward the inner cavity 114 of the housing 106.

Still referring to FIG. 48, in yet another embodiment, the functional aperture 506f is provided as an opening for a positioning element of the dispensing system 100 that aids in the deployment thereof. Similarly, the functional aperture 506g may expose a mounting element of the dispensing system 100. In another embodiment, the functional aperture 506h facilitates the operation of a movable joint or other structural component of the dispensing system 100. For instance, in some embodiments, the cutouts 182a,b are considered functional apertures 506g since they facilitate the operation of the pivot joint 112 and the snapping on or off of the front cover 108 from the hinge 170 at the rear cover 110. It is contemplated that the cutouts 182a,b permit temporary deflection and bending of the hinge 170 area, such that the fins 172a,b can diffuse bending forces during the snapping instead of absorbing such forces that may cause the fins 172a,b to bend and break. Indeed, in some embodiments holes or apertures for receipt of structural components of a hinge or bending element may also be considered to be a functional aperture 506h.

In yet another embodiment, the dispensing system 100 comprises a functional aperture 506i that provides access to a user interface and/or a functional aperture 506j that provides access to a control panel. In such cases, the functional aperture 506j is an opening that allows user interaction or viewing of a state or condition of the dispensing system 100. For instance, the user can alter settings on the control panel and/or user interface to adjust various operational parameters, such as a dispensing parameter, a timing parameter, a sensor parameter, etc. Indeed, such functional apertures 506i, 506j may broadly encompass any display whether interactive with a user or not. In fact, such apertures may be said to encompass any electrical component. Indeed, another functional aperture 506k may be provided for receipt or viewing of a light. For instance, the functional aperture 506k may allow a light to be emitted from an LED or other lighting means and/or to allow a light emitting structure to extend wholly or partially therethrough.

Still further, the dispensing system 100 can comprise a functional aperture 5061 that provides functional access to the product container 104 inserted within the dispensing system 100. Specifically, such access allows the user to insert and/or remove the product container 104 from the dispensing system 100.

Further, it is contemplated that a kit can be provided for the dispensing systems 100, 300. For instance, the kit can include the dispenser 102, the product container 104, and the mounting bracket 400. Preferably, the dispenser 102 may be characterized as a multi-directional actuation mechanism having at least two actuators, such as the front cover 108 and rear cover 110, and/or any portions thereof such as the top cover 118. It is contemplated that the at least two actuators permit hand-held use of the dispenser to spray the product that is contained in the product container 104. Further, the mounting bracket 400 operatively holds the dispenser 102 by one of the at least two actuators.

In another embodiment, the kit includes use instructions on operation of the dispenser 102 in the handheld position, in the upright position on a support surface, and in the mounted position on a wall. For instance, the instructions may include directions to hold the dispenser 102 in the user's hand and squeeze or rotate the front cover 108 and/or the rear cover 110 together. For operation in the upright position, the instructions may include directions to squeeze or rotate the front and/or rear covers 108, 110 together while the dispenser 102 rests on a flat resting surface, such as a table top. Further, mounting instructions can be included for docking the dispenser 102 and operating it therefrom. For instance, the mounting instructions may instruct the user to hang the mounting bracket 400 on a nail or other protrusion that is received through the mounting hole 412, such that back surface 434 of the bracket 400 is flush against the wall. Alternatively, the instructions can instruct the user to provide or apply an adhesive on the back surface 434 of the mounting bracket 400. With the mounting bracket 400 deployed, the instructions can further indicate that the rear cover 110 should be slid onto the bracket 400 such that the lower end 120b of the cover 110 is received in the slot 428 defined behind the prongs 426a,b. The instructions may also include directions on how to actuate the front cover 108 from its mounted position on a wall to emit a spray. Further, instructions may be included for replacing the product container 104 with another refill product container by lifting up the hingedly-attached front cover 108, removing the used-up product container, and inserting a new product container by snapping the mounting cup immediately above the collar 152. If the kit includes the shroud 260, the instructions can include directions on inserting the shroud 260 into the collar 332 of the dispensing system 300. Further, instructions may be provided directing that the user position the shroud 260 such that the left and right shoulders 274a,b of the shroud 260 are disposed beneath the collar 332.

Any of the embodiments provided herein may be modified to include any of the structures or methodologies disclosed in connection with different embodiments. All documents cited in the Detailed Description of the Invention are, in relevant part, entirely incorporated herein by reference; the citation of any document is not to be construed as an admission that it is prior art with respect to the present invention.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A dispensing system, comprising:
a housing for receipt of a product to be dispensed; and
a discharge orifice for emission of the product;
wherein the housing includes at least one decorative recessed portion that does not extend completely through the housing and at least one decorative aperture that does extend completely through the housing, and
wherein one or more optional apertures are provided within the housing for receipt or viewing of a functional component of the system.

2. The dispensing system of claim 1, wherein the optional aperture includes one or more of:
a sensor port;
an opening for receipt or viewing of a light;
an opening for a switch, button, or trigger;
an opening for an interface or control panel to allow user interaction or viewing of a state or condition of the system;
an opening for a positioning or mounting element;
an opening to provide access for insertion or removal of a product; and
an opening for a hinge or member that is movable during use of the system.

3. The dispensing system of claim 2, wherein the housing includes a plurality of decorative recessed portions and a plurality of decorative apertures.

4. The dispensing system of claim 2, wherein the housing includes front and rear covers hingedly connected to one another, and the at least one decorative recessed portion and the at least one decorative aperture are provided on the front cover.

5. The dispensing system of claim 4, wherein the front cover includes a plurality of decorative recessed portions and a plurality of decorative apertures.

6. The dispensing system of claim 5, wherein the housing includes at least one decorative recessed portion and at least one decorative aperture on the rear cover.

7. The dispensing system of claim 6, wherein the rear cover includes a plurality of decorative recessed portions and a plurality of decorative apertures.

8. The dispensing system of claim 4, wherein the front cover includes an outer surface of a front wall with an interrupted surface area of between about 5% to about 40%.

9. The dispensing system of claim 8, wherein a ratio R of the total interrupted surface area to the non-interrupted surface area of the front wall is about 1:3.

10. The dispensing system of claim 4, wherein the housing includes at least one decorative recessed portion and at least one decorative aperture on the rear cover.

11. The dispensing system of claim 10, wherein the rear cover includes an outer surface with an interrupted surface area of between about 5% to about 20%.

12. The dispensing system of claim 11, wherein a ratio R of the total interrupted surface area to the non-interrupted surface area of the rear wall is about 3:20.

13. A kit for a dispensing system, comprising:
a dispenser including a multi-directional actuation mechanism with at least two actuators for hand-held use of the dispenser to spray a product;
a container holding the product; and
a bracket for operatively holding the dispenser by one of the at least two actuators.

14. The kit for a dispensing system of claim 13 further including use instructions on operation of the dispenser in a handheld position, in an upright position on a support surface, and in a mounted position on a wall.

15. A bracket for retaining a dispenser, comprising:
a plate adapted to be secured to a wall, the plate having at least two parallel ribs extending between a lower end and an upper end thereof; and
a shelf extending from the lower end of the plate, wherein at least two prongs extend from the shelf.

16. The bracket of claim 15, wherein the at least two parallel ribs extend upwardly from the shelf toward the upper end of the plate.

17. The bracket of claim 16, wherein a slot is defined between the at least two prongs and the plate.

18. The bracket of claim 17, wherein a standoff rib is provided above the at least two parallel ribs and closer to the upper end of the plate.

19. The bracket of claim 18, wherein a snap element is provided adjacent the upper end of the plate and above the at least two parallel ribs and the standoff rib.

20. The bracket of claim 15 being provided in a kit, the kit further including a housing for receipt of a product to be dispensed and a container holding the product.
